(19) United States
(12) Patent Application Publication
(10) Pub. No.: US 2019/0291864 A1
(43) Pub. Date: Sep. 26, 2019

(54) TRANSFORMABLE APPARATUS

(71) Applicant: SZ DJI TECHNOLOGY CO., LTD., Shenzhen (CN)

(72) Inventors: Yifen LIU, Shenzhen (CN); Yumian DENG, Shenzhen (CN)

(21) Appl. No.: 16/438,032

(22) Filed: Jun. 11, 2019

Related U.S. Application Data
(63) Continuation of application No. PCT/CN2016/112110, filed on Dec. 26, 2016.

(51) Int. Cl. B64C 37/00; B64C 39/02; B64D 47/08; G03B 15/00; G03B 17/56; H04N 7/18

(52) U.S. Cl. CPC B64C 37/00; B64C 39/024; B64D 47/08; B64C 2201/127; G03B 17/561; H04N 7/185; B64C 2201/027; G03B 15/006

(57) ABSTRACT

A transformable apparatus includes one or more components configured to be movable relative to another component of the transformable apparatus, a trigger mechanism configured to initiate a transformation of the transformable apparatus between a vehicle configuration and a handheld configuration at least in part by causing a movement of the one or more components relative to the other component, and one or more propulsion units configured to effect self-propulsion of the transformable apparatus when the transformable apparatus is in the vehicle configuration. The transformable apparatus is configured to be held by a human hand when in the handheld configuration.

### CROSS-REFERENCE TO RELATED APPLICATION

This application is a continuation of International Application No. PCT/CN2016/112110, filed on Dec. 26, 2016, the entire contents of which are incorporated herein by reference.

### BACKGROUND OF THE DISCLOSURE

Unmanned vehicles, such as ground vehicles, aerial vehicles, surface vehicles, underwater vehicles, and spacecraft, have been developed for a wide range of applications including surveillance, search and rescue operations, exploration, and other fields. In some instances, unmanned vehicles may carry a payload configured to collect data during operation. For example, unmanned aerial vehicles (UAV) may be equipped with image capture devices, such as cameras, for aerial photography. A payload may be coupled to an unmanned vehicle via a carrier that provides movement of the payload in one or more degrees of freedom. Further, unmanned vehicle may be outfitted with one or more functional units and components, such as various sensors for collecting different types of data from the surrounding environment.

### SUMMARY OF THE DISCLOSURE

A need exists for improving portability, usability and availability of vehicles, such as aerial vehicle, for example unmanned aerial vehicles (UAVs). The improved vehicles herein may be a transformable apparatus capable of transforming between a first configuration and a second configuration. The transformation of the transformable apparatus between the first configuration and the second configuration can be realized by movement of one or more components of the transformable apparatus relative to another component of the transformable apparatus. In the first configuration, the transformable apparatus may be capable of vehicle operations. In the second configuration, the transformable apparatus may be capable of being held by a human hand, for example, by a single hand of a user. In this way, the transformable apparatus may support both the vehicle operations and handheld operations, and thus a user may be able to maneuver the transformable apparatus by direct manual manipulations.

An aspect of the disclosure is directed to a transformable apparatus, comprising: one or more components configured to be movable relative to another component of the transformable apparatus; a trigger mechanism configured to initiate a transformation of the transformable apparatus between a vehicle configuration and a handheld configuration at least in part by causing a movement of the one or more components relative to the other component; and one or more propulsion units configured to effect self-propulsion of the transformable apparatus when the transformable apparatus is in the vehicle configuration, wherein the transformable apparatus is configured to be held by a human hand when in the handheld configuration.

An aspect of the disclosure is directed to a method for operation of a transformable apparatus, said method comprising: initiating, with aid of a trigger mechanism, movement of one or more components of the transformable apparatus; effecting a transformation of the transformable apparatus between a vehicle configuration and a handheld configuration in response to the trigger mechanism; and enabling (1) self-propulsion of the transformable apparatus with aid of one or more propulsion units when the transformable apparatus is in the vehicle configuration, and (2) holding the transformable apparatus by a human hand when the transformable apparatus is in the handheld configuration.

An additional aspect of the disclosure is directed to a user interaction apparatus comprising: an interaction assembly configured to receive a user input to initiate movement of one or more components of a transformable apparatus such that the transformable apparatus is transformed between a first configuration and a second configuration; and a performance assembly configured to effect a transformation of the transformable apparatus between the first configuration and the second configuration in response to the user input received by the interaction assembly, wherein the transformable apparatus is configured to (1) be capable of self-propulsion with aid of one or more propulsion units when in the first configuration, and (2) require manual manipulation for movement when in the second configuration.

A method for operation of a user interaction apparatus is provided in a further aspect of the disclosure, said method comprising: receiving, with aid of an interaction assembly of the user interaction apparatus, a user input to initiate movement of one or more components of a transformable apparatus such that the transformable apparatus is transformed between a first configuration and a second configuration; and effecting, with aid of a performance assembly, a transformation of the transformable apparatus between the first configuration and the second configuration in response to the user input, wherein the transformable apparatus is configured to (1) be capable of self-propulsion with aid of one or more propulsion units when in the first configuration, and (2) require manual manipulation for movement when in the second configuration.

Moreover, aspects of the disclosure are directed to a transformable apparatus, said apparatus comprising: one or more components configured to be movable relative to another component of the transformable apparatus such that the transformable apparatus is transformed between a first configuration and a second configuration; and a trigger mechanism configured to initiate a transformation of the transformable apparatus between the first configuration and the second configuration, wherein (1) the transformable apparatus is configured to be capable of self-propulsion while capturing images when in the first configuration and is configured to require manual manipulation for movement while capturing images when in the second configuration, or (2) the transformable apparatus is configured for aerial operation when in the first configuration and is configured for ground level operation or lower when in the second configuration.

Further aspects of the disclosure are directed to a method for operation of a transformable apparatus, said method comprising: initiating, with aid of a trigger mechanism, movement of one or more components of the transformable apparatus such that the transformable apparatus is transformed between a first configuration and a second configuration; and effecting a transformation of the transformable apparatus between the first configuration and the second configuration in response to the trigger mechanism, wherein (1) the transformable apparatus is configured to be capable of self-propulsion while capturing images when in the first configuration and is configured to require manual manipulation for movement while capturing images when in the second configuration, or (2) the transformable apparatus is configured to aerial operation when in the first configuration and is configured for ground level operation or lower when in the second configuration.

In accordance with some aspects of the disclosure, a transformable apparatus may be provided, said transformable apparatus comprising: one or more components configured to be movable relative to another component of the transformable apparatus such that the transformable apparatus is transformed between a vehicle configuration and a handheld configuration, wherein the transformable apparatus is configured to capture images while in the vehicle configuration and the handheld configuration; and one or more propulsion units configured to effect self-propulsion of the transformable apparatus when the transformable apparatus is in the vehicle configuration, wherein the transformable apparatus is configured to be held by a human hand when in the handheld configuration.

Additionally, aspects of the disclosure may be directed to a method for operation of a transformable apparatus, said method comprising: effecting movement of one or more components of the transformable apparatus such that the transformable apparatus is transformed between a vehicle configuration and a handheld configuration, wherein the transformable apparatus is configured to capture images while in the vehicle configuration and the handheld configuration; and permitting (1) self-propulsion of the transformable apparatus via one or more propulsion units when the transformable apparatus is in the vehicle configuration, and (2) the transformable apparatus to be held by a human hand when the transformable apparatus is in the handheld configuration.

An aspect of the disclosure may be directed to an apparatus comprising: one or more functional units configured to operate in a first state when the apparatus is in a first mode and operate in a second state different from the first state when the apparatus is in a second mode; and a control system configured to effect operation of the one or more functional units in the first state or the second state, wherein (1) the apparatus is configured to be capable of self-propulsion when in the first mode and is configured to require manual manipulation for movement when in the second mode, or (2) the apparatus is configured for aerial operation when in the first mode and is configured for ground level operation or lower when in the second mode.

Another aspect of the disclosure may be directed to a method for operation of an apparatus, said method comprising: effecting operation, with aid of a control system, of one or more functional units of the apparatus in a first state when the apparatus is in a first mode and in a second state different from the first state when the apparatus is in a second mode, wherein (1) the apparatus is configured to be capable of self-propulsion when in the first mode and is configured to require manual manipulation for movement when in the second mode, or (2) the apparatus is configured for aerial operation when in the first mode and is configured for ground level operation or lower when in the second mode.

It shall be understood that different aspects of the disclosure may be appreciated individually, collectively, or in combination with each other. Various aspects of the disclosure described herein may be applied to any of the particular applications set forth below or for any other types of movable objects. Any description herein of an aerial vehicle may apply to and be used for any movable object, such as any vehicle. Additionally, the apparatuses and methods disclosed herein in the context of aerial motion (e.g., flight) may also be applied in the context of other types of motion, such as movement on the ground or on water, underwater motion, or motion in space.

Other objects and features of the disclosure will become apparent by a review of the specification, claims, and appended figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference in its entirety.

### BRIEF DESCRIPTION OF THE DRAWINGS

The novel features of the invention are set forth with particularity in the appended claims. A better understanding of the features and advantages of the disclosure will be obtained by reference to the following detailed description that sets forth illustrative embodiments, in which the principles of the disclosure are utilized, and the accompanying drawings of which:

FIG. 1 shows a schematic view of a transformable apparatus that transforms between a first configuration and a second configuration, in accordance with embodiments of the disclosure.

FIG. 2 shows a schematic view of a transformable apparatus in a second configuration, in accordance with embodiments of the disclosure.

FIG. 3 shows a flow chart of a method for effecting a transformation of a transformable apparatus, in accordance with embodiments of the disclosure.

FIG. 4 provides an illustration of a transformable apparatus performing image capturing in both a first configuration and a second configuration, in accordance with embodiments of the disclosure.

FIG. 5 provides an illustration of changes of functional operations of an apparatus as the apparatus transforms between a first mode and a second mode, in accordance with embodiments of the disclosure.

FIG. 6 provides an illustration of a trigger mechanism for triggering a transformation of a transformable apparatus, in accordance with embodiments of the disclosure.

FIG. 7 shows a flow chart of a method for operation of a transformable apparatus with aid of a trigger mechanism, in accordance with embodiments of the disclosure.

FIG. 8 provides an illustration of different types of external inputs to a trigger mechanism, in accordance with embodiments of the disclosure.

FIG. 9 provides an illustration of different types of internal inputs to a trigger mechanism, in accordance with embodiments of the disclosure.

FIG. 10 provides a schematic of an interaction operation between a user interaction apparatus and a transformable apparatus, in accordance with embodiments of the disclosure.

FIG. 11 shows schematic views of different interaction assemblies with different dispositions for user interaction, in accordance with embodiments of the disclosure.

FIG. 12 shows different schematic views of an unmanned aerial vehicle (UAV) transformed between a first configuration and a second configuration, in accordance with embodiments of the disclosure.

FIG. 13 shows different schematic views of a UAV transformed into a handheld or tripod configuration, in accordance with embodiments of the disclosure.

FIG. 14 shows different schematic views of a UAV in a first mode and a second mode, in accordance with embodiments of the disclosure.

FIG. 15 illustrates a movable object in accordance with embodiments of the disclosure.

FIG. 16 illustrates a system for controlling a movable object, in accordance with embodiments of the disclosure.

### DETAILED DESCRIPTION OF THE EMBODIMENTS

Systems, devices and methods are provided for operating an apparatus in different modes or operating a transformable apparatus in different configurations. The apparatus in a first mode or the transformable apparatus in a first or a vehicle configuration may be a vehicle, for example, an unmanned vehicle, such as an unmanned ground vehicle or an unmanned aerial vehicle (UAV). The apparatus in a second mode or the transformable apparatus in a second or a handheld configuration may be a handheld device. Any description herein of a UAV may apply to any type of aerial vehicle or movable object, or vice versa.

The apparatus herein may, without any transformation, support a first mode in which it is capable of self-propulsion or aerial operation and a second mode in which manual manipulation is required for movement or it is configured for ground level or lower operations. The apparatus may comprise one or more functional units, including but not limited to a power system, a flight controller, an image transmission system, a propulsion system, a cooling system, a gimbal and an image capture device. The one or more functional units may be in a first state when the apparatus is in the first mode and in a second state when the apparatus is in the second mode. The apparatus may comprise a control system capable of effecting operation of the one or more functional units in different states.

The apparatus herein may be a UAV when in the first mode and may be a handheld device configured to be carried by a single hand when in the second mode. Based on the mode of the apparatus, the one or more functional units may operate in a corresponding state. For example, an image transmission system of the apparatus may operate in a wireless state in the first mode and may operate in a wired state in the second mode. Similarly, the image transmission system may operate at a reduced transmission power in the second mode relative to the first mode. In this manner, the one or more functional units become more suitable for operating in different modes of the apparatus, thereby enhancing the flexibility and usability of the apparatus.

The transformable apparatus herein may comprise one or more components that are moveable relative to another component. The transformable apparatus may be transformable between a first configuration and a second configuration at least in part by causing a movement of the one or more components relative to the other component. In the first configuration, the transformable apparatus may be capable of self-propulsion with aid of one or more propulsion units. The propulsion units may be supported by one or more arms of the transformable apparatus to generate lift for aerial operations. In the second configuration, the transformable apparatus may require manual manipulation for movement. For example, when the transformable apparatus is transformed into the second configuration by moving one or more components thereof, a user can hold the transformable apparatus by a single hand and perform handheld operations. For instance, when an image capture device is attached or mounted to the transformable apparatus, the user may directly take pictures or make a video while the transformable apparatus is in flight, or while using the transformable apparatus as a handheld image capture device.

The transformable apparatus may transform via movement of one or more components. The movement herein may be folding or unfolding of the one or more components relative to another component or extending or retracting of the one or more components relative to another component. For example, one or more arms of the transformable apparatus may be unfolded out from a central body of the transformable apparatus when the transformable apparatus is in the first configuration for aerial operation and folded against the central body of the transformable apparatus when the transformable apparatus is in the second configuration for handheld operations. Additionally or alternatively, the one or more components of the transformable apparatus may be extended out from the central body of the transformable apparatus in the first configuration and may be retracted into the central body of the transformable apparatus in the second configuration. In some instances, one or more actuators may aid in the transformation of the transformable apparatus. In this manner, the portability and availability of the transformable apparatus is improved and the functionality of the transformable apparatus is further expanded since it may not only perform aerial operations but also support handheld operations. When the transformable apparatus is implemented as a UAV in the first configuration, this may advantageously provide greater flexibility to a user to use the UAV under different circumstances. This may also make it easier for a user to manipulate the UAV in the different configurations without needing to worry about separate components.

To easily control the transformable apparatus to transform between the first configuration and the second configuration, a user interaction apparatus may also be provided for user interaction with the transformable apparatus. The user interaction apparatus may be able to receive a user input to initiate movement of one or more components of the transformable apparatus such that the transformable apparatus is transformed between the first configuration and the second configuration. To this end, the user interaction apparatus may comprise an interaction assembly, such as a touchscreen, configured to receive user input. Optionally, the user input may control a gimbal that has been coupled to the transformable apparatus, or adjust settings of the gimbal. Thereby, the gimbal may be suitable for use in the second configuration, for example, for handheld shooting when an image capture device is attached to the gimbal. This advantageously allows easy data collection, such as image capture, by the transformable apparatus in various configurations.

In some implementations, the transformation of the transformable apparatus between the first configuration and the second configuration may be initiated or triggered by a trigger mechanism. For example, the trigger mechanism may switch the configuration of the transformable apparatus in response to an external input. Alternatively, the trigger mechanism may switch the configuration of the transformable apparatus based on internal data including sensor/vehicle operational data. The sensor data herein may be collected by a variety of sensors on-board the transformable apparatus. The vehicle operational data herein may be obtained from one or more functional units of the transformable apparatus, such as the one or more propulsion units of the transformable apparatus. With aid of the trigger mechanism, the transformation of the transformable apparatus may be done in a controlled manner. Use of the trigger mechanism may also allow the transformable apparatus to change configuration in an easy-to-use manner.

Various embodiments of the disclosure are next described in detail below with reference to the drawings.

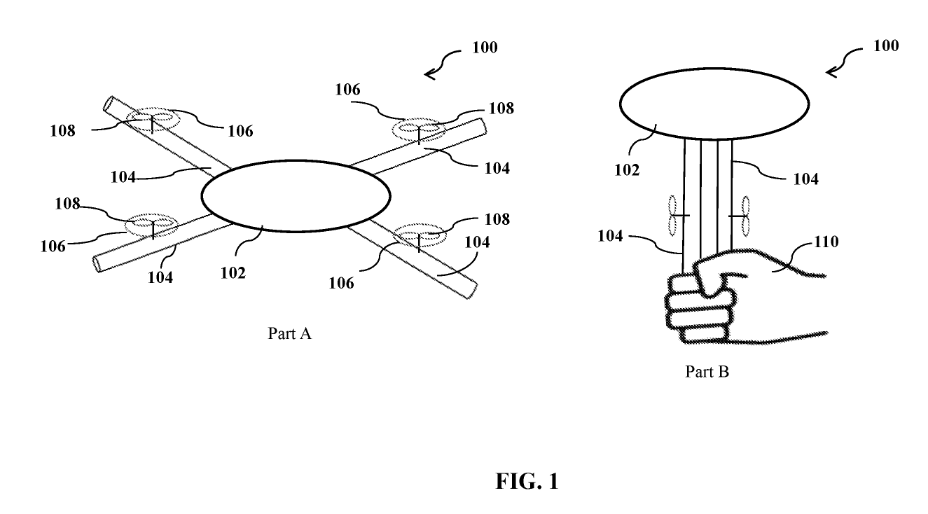

FIG. 1 shows a schematic view of a transformable apparatus 100 that transforms between a first configuration and a second configuration, in accordance with embodiments of the disclosure. The transformable apparatus herein may be a movable object, such as an unmanned aerial vehicle (UAV). The transformable apparatus may function as the movable object, such as the UAV, in a first configuration, and may transform into a different second configuration. Any description herein of a UAV may apply to any type of movable object and vice versa. Any description herein of a UAV may apply to any type of aerial vehicle, or unmanned vehicle. The moveable object may be a motorized vehicle or vessel having one or more fixed or movable arms, wings, extended sections, and/or propulsion units.

A transformation of a transformable apparatus may include a physical transformation of the object. The transformation herein may comprise movement of at least one component of the transformable apparatus relative to another component of the transformable apparatus. In some instances, a plurality of components of the transformable apparatus may move relative to one or more other components of the transformable apparatus. One or more components of the transformable apparatus may move relative to a central body or a region of the transformable apparatus. Movement of the one or more components of the transformable apparatus may include a rotation about one, two, or three axes relative to another component of the transformable apparatus. Alternatively or additionally, movement of the one or more components of the transformable apparatus may include a transformation along one, two, or three axes relative to another component of the transformable apparatus. The one, two, or three axes may be one or more of a yaw, pitch, or roll axis of the transformable apparatus. When multiple components are movable, they move rotationally and/or translationally with respect to the same one, two, or three axes, or different axes. Movements may include pivoting, folding, sliding, telescoping, or any combination thereof, during transformation. In some embodiments, the one or more components that may be moving may be components other than propulsion units of the transformable apparatus. Optionally, the one or more components that may be moving may include a component that supports a propulsion unit of the transformable apparatus, such as an arm or leg.

A transformation of the transformable apparatus may result in a change in overall size of the transformable apparatus between a first configuration and a second configuration. For instance, the transformable apparatus may take up a larger space in the first configuration than the second configuration, or vice versa. The transformable apparatus may be in an expanded state in the first configuration and a retracted state in the second configuration, or vice versa. The transformable apparatus may have a larger footprint (e.g., lateral or vertical) in the first configuration than in the second configuration, or vice versa. The transformable apparatus may have a greater maximum dimension (e.g., length, width, height, diagonal, or diameter) in the first configuration than in the second configuration or vice versa.

Optionally, a transformation of the transformable apparatus may result in a change in overall shape of the transformable apparatus between a first and second configuration. For instance, in the first configuration, the transformable apparatus may have a shape that encompasses more lateral space and less vertical space than a second configuration, or vice versa. The transformable apparatus may have a substantially symmetrical shape (e.g., symmetrical about a plane, radially symmetrical) in the first configuration and not in the second configuration, or vice versa. The transformable apparatus may have a center of mass within a central body in the first configuration and not in the second configuration, or vice versa. A lateral cross section shape and/or a vertical cross section shape of the transformable apparatus may be different between the first and second configurations.

A user may interact with the transformable apparatus in a different manner between the first configuration and the second configuration. For instance, the user may hold and/or support the transformable apparatus in a different manner between the first and second configurations. For instance, in the first configuration, the user may hold or support the transformable apparatus from a central body or landing stand, or may not hold the transformable apparatus at all when the transformable apparatus is in motion. In the second configuration, the user may hold or support the transformable apparatus from an arm or any form of handle, and the user may need to support the transformable apparatus as it may not be configured to be in motion. In the first configuration, the user may not be directly physically contacting and manipulating the transformable apparatus while the transformable apparatus is collecting data (e.g., aerial imaging). In the second configuration, the user may be directly contacting and manipulating the transformable apparatus while the transformable apparatus is collecting data (e.g., handheld imaging).

In some embodiments, when a transformable apparatus is in a first configuration, the transformable apparatus may be capable of self-propulsion. The transformable apparatus may be capable of moving within an environment without requiring direct manual contact or manipulation from a user. In some embodiments, the environment may include the sky, space, land, and/or water. The transformable apparatus may include one or more propulsion units that may permit self-propulsion of the transformable apparatus. One or more the propulsion units may include a motor that may aid in the self-propulsion of the transformable apparatus. The propulsion units may include one or more rotors or wheels that may aid in self-propulsion of the transformable apparatus. The one or more propulsion units may permit the transformable apparatus to move in a controlled manner when actuated. The transformable apparatus may have an on-board energy storage and/or generation system that may provide power that allows the transformable apparatus to be self-propelled.

When a transformable apparatus is in a second configuration, the transformable apparatus may require manual aid to move. For instance, the transformable apparatus may be configured to be carried by a human operator, or loaded onto a device that may move (e.g., boom, bike, and vehicle). The transformable apparatus may have a component that may be easily gripped by a human operator, or that may be easily attached to a device that may move. The transformable apparatus may be configured for substantially stationary operation. For instance, the transformable apparatus may be configured to rest on a surface or be attached to a stationary object. For example, the transformable apparatus may become a tripod or similar type of supporting structure, capable of operation while stably resting on a surface. In some embodiments, the transformable apparatus may not have functioning propulsion units, or the operation of the propulsion units may be disabled, in the second configuration. In some instances, power from an on-board energy storage system and/or generation system may be prevented from powering the propulsion units in the second configuration. This may occur while other features, such as an imaging device or carrier of the transformable apparatus may be powered and/or in operation. In some embodiments, the transformable apparatus may have propulsion units that may not be configured in a way that may permit controlled movement of the transformable apparatus, even if actuated. When in the second configuration, the transformable apparatus may be sized and/or shaped so that components of the transformable apparatus do not interfere with manual manipulation of the transformable apparatus.

A transformable apparatus may be configured for aerial operation in a first configuration. For instance, the transformable apparatus may be configured for flight. The transformable apparatus may be configured to collect data while in flight. The transformable apparatus may be configured to capture images while in flight. The transformable apparatus may be configured to transmit images to a remote device while in flight. The transformable apparatus may be configured for aerial imaging in the first configuration.

The transformable apparatus may be configured for ground level or lower operation in a second configuration. The transformable apparatus may be configured to collect data while at a ground level or lower. The transformable apparatus may be configured to capture images while at a ground level or lower. The transformable apparatus may be configured to transmit images to a device while at a ground level or lower. The transformable apparatus may be configured for ground level or lower imaging in the second configuration. The transformable apparatus may be on a surface, or carried by a human or other device on a surface. The surface may be the ground, underground, water, or underwater. Optionally, the transformable apparatus may not be configured for aerial operation in the second configuration. The transformable apparatus may not be capable of flight, or may have a flight functionality disabled while in the second configuration. Other functions of the transformable apparatus, such as data collection (e.g., imaging) may be permitted during the second configuration.

Part A of FIG. 1 shows an example of a transformable apparatus in a first configuration. In one example, the transformable apparatus in the first configuration may be a UAV. Any description herein of a UAV may apply to any type of movable object or object useful for aerial imaging, and vice versa. Any description herein of a UAV may apply to a transformable apparatus in a first configuration or vice versa.

A UAV may include a UAV body 102. The UAV body may be a central body. A center of gravity of the UAV may be within the UAV body, above a UAV body, or below a UAV body. A center of gravity of the UAV may pass through an axis extending vertically through the UAV body. The UAV body may support one or more arms 104 of the UAV extendable from the UAV body. The UAV body may bear weight of the one or more arms. The UAV body may directly contact one or more arms. The UAV body may be integrally formed with one or more arms or components of one or more arms. The UAV may connect to the one or more arms via one or more intermediary pieces.

The UAV body may be formed from a solid piece. Alternatively, the UAV body may be hollow or may include one or more cavities therein. The UAV body may have any shape and size. For example, a shape of the UAV body may be rectangular, prismatic, spherical, ellipsoidal, or the like. The UAV may have a substantially disc-like shape in some embodiments.

The UAV body may include a housing that may partially or completely enclose one or more components therein. The components may include one or more electrical components. Examples of components may include, but are not limited to, a flight controller, one or more processors, one or more memory storage units, a communication unit, a display, a navigation unit, one or more sensors, a power supply and/or control unit, one or more electronic speed control (ESC) modules, one or more inertial measurement units (IMU) or any other components. Similarly, any of the components described may be disposed on, within, or embedded in an arm of the UAV. The arms may optionally include one or more cavities that may house one or more of the components (e.g., electrical components). In one example, the arms may or may not have inertial sensors that may provide information about a position (e.g., orientation, spatial location) or movement of the arms. The various components described may be distributed on a body of the UAV, the arms of the UAV, or any combination thereof.

Further, the UAV can have any number of arms. For example, the UAV can have one, two, three, four, five, six, seven, eight, nine, ten, or more than ten arms. The arms may optionally extend radially from the central body. The arms may be arranged symmetrically about a plane intersecting the central body of the UAV. Alternatively, the arms may be arranged symmetrically in a radial fashion.

The plurality of arms may support one or more propulsion units 106 carrying one or more rotor blades 108. The rotor blades may be actuated by a motor or an engine to generate a lift force for the UAV. For example, the rotor blades may be affixed to a rotor of a motor such that the rotor blades rotate with the rotor to generate a lift force (thrust). The arms may be affixed to the central body such that the arms and the central body are movable as a whole (as the UAV).

The plurality of arms as shown may be rotatably coupled to the central body via a plurality of joints (not shown). The joints may be located at or near the perimeter of the central body. Optionally, the joints may be located on the sides or edges of the central body. The plurality of joints may be configured to permit the arms to rotate relative to a plurality of rotational axes. The plurality of rotational axes may be parallel, orthogonal, or oblique to one another. The plurality of rotational axes may also be parallel, orthogonal, or oblique to one or more of a roll axis, a pitch axis, and a yaw axis of the UAV.

In the first configuration as shown at Part A of FIG. 1, the UAV may be capable of self-propulsion via one or more propulsion units. For example, as the rotation of the rotor blades carried by the propulsion units, the thrust forces may be generated for lifting the UAV upward. Further, based on the speed control with aid of a speed controller embedded in the central body of the UAV, the rotor blades may rotate at different rotational speeds, thereby the UAV flying around in the air as an aerial vehicle. The UAV may perform various aerial operations, such as aerial photography when an image capture device is coupled to the UAV, which may be controlled in real time by an operator in a wireless manner.

The UAV may be capable of autonomous flight, semi-autonomous flight, and/or manually controlled flight. For instance, a user may control flight of the UAV with aid of a remote terminal. The UAV may be capable of taking off and/or landing on a surface. The UAV may be capable of capturing images using an image capture device while in flight. The UAV may be capable of capturing images using the image capture device while the UAV is landed on a surface.

A transformable apparatus may be transformable between a first configuration and a second configuration. For instance, after completing the operations in the first configuration, the UAV may be transformed into the second configuration. As previously described, in the second configuration, self-propulsion may be disabled and manual manipulation may be needed for movement of the UAV. The transformation of the UAV may be implemented by movement of one or more components of the UAV relative to another component of the UAV. The one or more movable components herein may be coupled to the other component or coupled to each other using any coupling mechanism, such as fasteners, actuation elements, joints, hinges, bolts, screws, etc. Examples of one or more movable components may include, but are not limited to, UAV arms, legs, landing stands, rotor blades, portions of the central body, carrier, payload, or any other component of the UAV. The one or more movable components may be in an extended state when the UAV is in the first configuration and may be in a retracted state when the UAV is in the second configuration. Thereby, state transitions of the one or more components between the extended state and the retracted state may render the UAV transformable between the first configuration and the second configuration, as will be discussed in great detail below.

Referring to a Part B of FIG. 1, the transformable apparatus may be transformed into a second configuration. For instance, a UAV may be transformed by folding one or more foldable arms downward from an extended state into a retracted state. In a second configuration, the UAV may optionally not be self-propelled. The UAV may be configured for ground level or lower operation. As shown, in the second configuration, the transformable apparatus may be able to be held by a single hand 110. One or more folded arms may be used as a handle and the propulsion units of the UAV may optionally cease operation. In the second configuration, the UAV may be transformed into a handheld device, which may be used for handheld operations at a ground level or even lower operations. For example, when an image capture device is attached to the UAV, the operator may grasp the UAV and move around to take photos or making a video. In some instances, some components of the UAV may be folded or retracted such that the UAV may form a support for holding the image capture device.

The above has discussed the transformable apparatus of the disclosure using the UAV as a non-limiting example. It should be noted that the disclosure is not limited to the UAV but may apply to any suitable vehicle, for example, an unmanned vehicle, such as an unmanned ground vehicle. In this case, one or more propulsion units of the unmanned ground vehicle may include one or more wheels, which may rotate to drive the unmanned ground vehicle to move forward or backward or turn around. The one or more wheels may be attached to a chassis system of the unmanned ground vehicle. Further, based on the descriptions made with reference to FIG. 1, it is to be understood that the transformable apparatus of the disclosure may be transformed between the first configuration and the second configuration with aid of the relative movements of the one or more components of the transformable apparatus. In some embodiments, the transformable apparatus may be capable of self-propulsion in the first configuration and incapable of self-propulsion in the second configuration. In the second configuration, manual manipulations from a user or an operator are needed for movement of the transformable apparatus. In some embodiments, the transformable apparatus may operate to fly through the air in the first configuration, e.g., perform aerial operations, and may perform ground level or lower operations in the second configuration.

As discussed before, the transformable apparatus may be capable of self-propulsion with aid of one or more propulsion units thereof in the first configuration. For example, as one or more rotor blades carried by the one or more propulsion units of the transformable apparatus rotate, a propulsive force may be generated for lifting and propelling the transformable apparatus to fly around in the air. In this first configuration, depending on power source obtained from, e.g., one or more battery units arranged or mounted on the transformable apparatus, the transformable apparatus may not need any external force or means to get propelled. In some instances, in order to be self-propelled, the transformable apparatus may be outfitted with energy conversion units, for converting any other types of energy into electric energy. For example, the transformable apparatus may be outfitted with solar cells for converting the solar energy into the electric energy. When flying in the air, the transformable apparatus may perform aerial operations as desired by the operator, for example, collection of environmental data, aerial photography, aerial surveillance, aerial survey, real-time image transmission, etc. The aerial operations herein may be controlled by the operator in real time with aid of a remote controller, which may have a visual display for a user interaction.

In contrast, after transformed from the first configuration to the second configuration via relative movement of the one or more components of the transformable apparatus, the transformable apparatus may not be self-propelled in the second configuration but may get propelled by an external force or means. In some embodiments, the external force may be obtained from a human hand, e.g., a single hand of a user. By grasping the transformable apparatus in the second configuration, the operator may be able to use the transformable apparatus as a handheld device or apparatus. In some other embodiments, the external means may be a moving object, such as a bike, a car, a boom, etc, whose movement may cause the transformable apparatus loaded or mounted thereto to move together.

During the course of the second configuration, the transformable apparatus may be capable of ground level or lower operations. In some instances, when an image capture device is attached to the transformable apparatus, the transformable apparatus may function as a holder for holding the image capture device. Thereby, the user may carry the transformable apparatus to move around and take photos or record a video. In some embodiments, the image capture device may be attached to the UAV via a carrier, such as a gimbal, which may be removably connected to the UAV. Any description herein of a gimbal may apply to any type of carrier that may be capable of supporting a payload, such as an image capture device. In this case, the user may be able to control orientation of the image capture device with aid of the gimbal. For example, by virtue of the gimbal, the user may control the image capture device to rotate about at least one of a roll axis, a yaw axis, and a pitch axis. In some embodiments, a stabilization assembly may be sandwiched between the image capture device and gimbal when the gimbal supports the image capture device in a vertical direction, i.e., in a direction of gravity. Optionally, a stabilization assembly may be provided between the gimbal and the transformable apparatus, such as a UAV body. In this manner, the vibration and judder or jitter of the image capture device in the vertical direction may be diminished or eliminated by the stabilization assembly. The stabilization assembly may include one or more elastic members (e.g., volute springs or tension springs), or one or more linkage mechanisms (e.g., parallelogram linkage) to generate a force that may equipoise the gravity force of the image capture device. Thereby, the user may be able to make stable ambulatory videography or cinematography.

In some instances, the one or more propulsion units of the transformable apparatus may still able to operate but with reduced power in the second configuration rather than being powered off as discussed before. In this case, the propulsion units of the transformable apparatus may not function as a main source for propelling the transformable apparatus but may provide an auxiliary force for aiding the operator in carrying the UAV. Therefore, the operator may move the UAV around with a less force as compared to the instance in which the propulsion units are switched off.

In some instances, in order to make it convenient for grasping or holding, the transformable apparatus of the disclosure may be ergonomically shaped for carrying by a single hand when in the second configuration. For example, the transformable apparatus may be configured to comprise a handle ergonomically designed to be carried by a single hand when in the second configuration. This handle may be a foldable or retractable component that can be unfolded or extended out from the transformable apparatus in the first configuration and folded or retracted towards the transformable apparatus in the second configuration for holding. As an alternative, the handle may be releasably coupled to the transformable apparatus. In this case, when the transformable apparatus is about to perform handheld operations in the second configuration, the user may couple the handle to the transformable apparatus, e.g., a central body thereof, via any suitable coupling means or mechanism.

As previously described, in some embodiments, the transformable apparatus may be a UAV in a first configuration, and a handheld device in a second configuration.

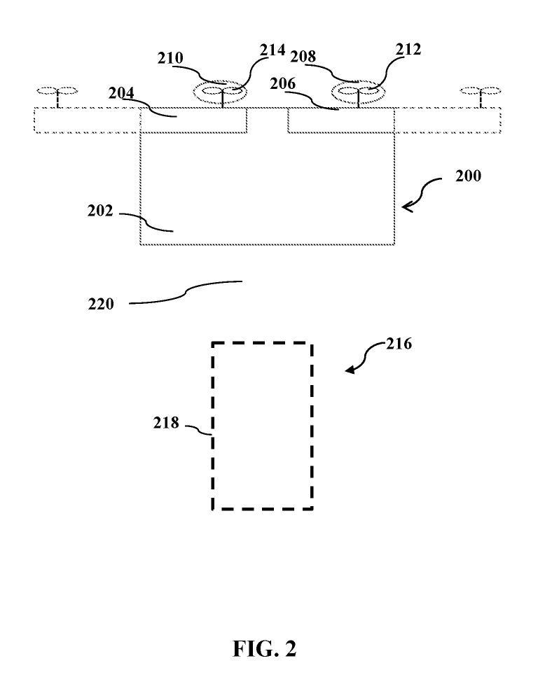

FIG. 2 shows a schematic view of a transformable apparatus 200 in a second configuration, in accordance with embodiments of the disclosure. The transformable apparatus may be a handheld device in the second configuration. The transformable apparatus may require manual manipulation for movement when in the second configuration. The details of the transformable apparatus in the second configuration will be discussed below using a UAV in a handheld configuration as an example. Any description herein of a UAV in a handheld configuration may apply to a transformable apparatus in a second configuration or vice versa.

Referring to FIG. 2, the transformable apparatus, which may be a UAV in the first configuration, may include a UAV body 202 and one or more arms 204, 206 retractable against the UAV body in the second configuration. The arms may have an elongated configuration. In some embodiments, each of the arms may be an elongated arm. An elongated arm may have a length that is greater than a cross-sectional dimension. The UAV may have any number of arms. For instance, the UAV may have one or more, two or more, three or more, four or more, five or more, six or more, seven or more, or eight or more. The arms may be evenly spaced apart. For instance, if N arms are provided for the UAV, the number of degrees between each arm may be 360/N. Alternatively, the arms need not be evenly spaced apart. In some instances, none of the arms are parallel to one another. Alternatively, arms may be arranged so that two or more, three or more, or four or more of the arms may be substantially parallel to one another.

One or more of the arms may support one or more propulsion units 208 and 210 that may effect flight of the UAV when the transformable apparatus is in the first configuration. In some embodiments, each arm may support one or more propulsion units. Alternatively, one or more of the arms may not support a propulsion unit. In some instances, each arm may support one or more, two or more, three or more, four or more, five or more, or ten or more propulsion units. Each arm may support the same number of propulsion units. Alternatively, different arms may support different numbers of propulsion units.

Propulsion units may be configured to generate lift for the UAV when the transformable apparatus is in the first configuration. A propulsion unit may include a rotor assembly. A rotor assembly may include one or more rotor blades 212 and 214 that may rotate to generate lift for the UAV when the transformable apparatus is in the first configuration. In some instances, a plurality of rotor blades may be provided for a propulsion unit. The plurality of rotor blades may or may not be movable relative to one another. The rotor assembly may include an actuator driving rotation of the rotor blades. The actuator may be coupled to the one or more rotor blades with aid of a shaft. Rotation of the actuator may cause rotation of the shaft, which may in turn cause rotation of the rotor blades. Any description herein of a shaft may also apply to multiple shafts that may be driven by the same actuator. The actuator may be driven by electrical energy, magnetic energy, thermal energy, mechanical energy, hydraulic pressure, or pneumatic pressure. The actuator may be a motor. In some embodiments, examples of the actuator may include self-commutated or externally commutated motors. Motors may include mechanical-commutator motors, electronic-commutator motors, synchronous machines, and/or asynchronous machines. Electric motors may include AC or DC motors. Some examples of motors may include direct-drive motors, step-less motors, or servomotors. The motors may be configured to rotate in a single direction, or may be capable of reversing direction. The rotor blades of each of the propulsion units of the UAV may turn, such that a first subset of the propulsion units has rotor blades rotating in a first direction and a second subset of the propulsion units has rotor blades rotating in a second direction, as described in greater detail elsewhere herein. Alternatively, the rotor blades may rotate in the same direction. Propulsion units may or may not include a protective covering that may be provided around at least a portion of the rotor blades.

In some embodiments, propulsion units may be located at or near a distal end of the arms. In some embodiments, arms may be coupled to the UAV body at a proximal end, and may have a distal end extending away from the UAV body. One or more of the propulsion units supported by the arm may be supported at a location along a length of the arm. Each arm may have propulsion units located within the same percentage or distance relative to the distal end of the arm. Alternatively, different arms may have propulsion units located at different percentages or distances relative to the distal end of the arm.

The propulsion units may be substantially located on an upper surface of the arms. The upper surface of the arms may be a surface of the arm opposing a lower surface of the arms, wherein the lower surface of the arms is facing a direction of gravity. The upper surface of the arms may be facing away from the direction of gravity. Alternatively, the propulsion units may be substantially located on a lower surface of the arms, on both the upper and lower surface of the arms, within an arm, or any combination thereof. In one example, one or more rotor blades of a propulsion unit may be located above an upper surface of an arm. Alternatively, one or more rotor blades of a propulsion unit may be located below a lower surface of the arm. In some instances, at least one rotor blade of a propulsion unit may be located above an upper surface of an arm while at least one rotor blade of the propulsion unit may be located below a lower surface of the arm. In some instances, an actuator of a propulsion unit may be located above an upper surface of an arm, below a lower surface of an arm, or within an arm. For instance, an actuator may be at least partially located within a cavity of the arm. The actuator may or may not partially extend above an upper surface of an arm and/or below a lower surface of the arm.

The transformable apparatus may carry a payload. The payload may include a device capable of sensing the environment about the transformable apparatus, a device capable of emitting a signal into the environment, and/or a device capable of interacting with the environment. One or more sensors may be provided as a payload, and may be capable of sensing the environment. An example of a sensor may be a camera. Any other sensors, such as those described elsewhere herein may be provided as a payload.

The payload may include one or more devices capable of emitting a signal into an environment. For instance, the payload may include an emitter along an electromagnetic spectrum (e.g., visible light emitter, ultraviolet emitter, infrared emitter). The payload may include a laser or any other type of electromagnetic emitter. The payload may emit one or more vibrations, such as ultrasonic signals. The payload may emit audible sounds (e.g., from a speaker). The payload may emit wireless signals, such as radio signals or other types of signals.

The payload may be stationary relative to a UAV body. The payload may be configured so that it does not move relative to the UAV body during operation of the UAV (e.g., flight of the UAV when the transformable apparatus is in the first configuration). The payload may be configured so that it does not move relative to the UAV body during operation of the payload (e.g., capturing images by a camera). The payload may be affixed relative to the UAV body.

The payload may be movable relative to a UAV body. The payload may be configured so that it is capable of movement relative to the UAV body during aerial operation of the UAV (e.g., flight of the UAV when the transformable apparatus is in the first configuration). The payload may be configured so that the payload is capable of movement relative to the UAV body during operation of the payload (e.g., capturing images by a camera). The payload may be supported with aid of one or more carriers or components that may enable the payload to move relative to the UAV body. For instance, a payload may translate along one, two or three directions relative to the UAV body, or rotate about one, two, or three axes relative to the UAV body. The carrier may permit a change in orientation of the payload relative to the UAV body. The payload may be supported by a carrier having a gimbaled frame assembly. Any characteristics described elsewhere herein for a payload and a carrier may be applied. The payload may be moved relative to the UAV body with aid of one or more actuators.

The payload may be supported by the UAV body. The payload may be supported by one or more arms of the UAV. The payload may be beneath the UAV body. The payload may be supported beneath a central body, above a central body, or on a side of a central body.

As illustrated in FIG. 2, the UAV has been transformed into a second or handheld configuration, wherein the transformable apparatus may have a handle 216 for being held by the user. It is to be understood that when the transformable apparatus is in the first configuration, the UAV in the vehicle configuration may be able to perform aerial operations such as those discussed before with reference to FIG. 1, and may be suitable for being held by user, particularly, in a single hand in the handheld configuration when the transformable apparatus is in the second configuration. The transformation between the vehicle configuration (or first configuration) and the handheld configuration (or the second configuration) herein may be implemented by folding arms against the central body or extending the arms out from the central body, as shown by dashed lines. For example, an arm of a UAV in a first configuration of the transformable apparatus, which may be useful for supporting a propulsion unit that may generate lift, may be moved relative to a central body of the UAV to form a handle of a handheld device in a second configuration of the transformable apparatus. In some embodiments, a single arm may be moved to form the handle, or multiple arms may be moved to form a handle. In some instances, one or more arms may be folded against the central body in the handheld configuration, which may allow the transformable apparatus to take up less space in the handheld configuration. A compact configuration may advantageously allow a user to manipulate the transformable apparatus with a single hand or two hands.

A handle of a transformable apparatus in a handheld configuration may be movable relative to a central body of the transformable apparatus. The handle may be movable between a vehicle configuration and a handheld configuration of the transformable apparatus. The handle may move by rotating with respect to one, two, or three axes. The handle may optionally move by telescoping, extending, and/or translating with respect to one, two, or three axes. Alternatively, the handle may be stationary or may remain stationary. The handle may serve a function other than acting as a handle when the apparatus is in the vehicle configuration. For example, the handle may support a propulsion unit when the transformable apparatus is in a vehicle configuration.

In some embodiments, the handle may be an independent component that can be coupled to a given position of the UAV, for example, a central body of the UAV via any coupling approaches. For example, the coupling herein may involve interference fits, clearance fits, transition fits, pivotal couplings including ball bearings, hinges, and other suitable rotary joints, or fixed couplings utilizing one or more fasteners, such as nails, screws, bolts, clips, ties, and the like.

The handle may be ergonomically designed or shaped to be carried by a single hand when in the handheld configuration. To this end, the handle may be configured to have a grasping region 218 configured to permit a user's fingers to at least partially wrap around the grasping region. The transformable apparatus may be configured such that when the user's fingers are at least partially wrapped around the grasping region, the user's wrist is at an ergonomically correct position when the transformable apparatus is used for ground level or lower operation (e.g., imaging). In some embodiments, the handle may be configured to have a substantially vertical or vertically slanted orientation while the user grasps the handle and operates the transformable apparatus. Alternatively, the handle may have a substantially horizontal or horizontally slanted orientation while the user grasps the handle and operates the transformable apparatus. The grasping region may be designed to have rough or uneven surface or texture, such that a frictional force between the hand and handle may be further increased for tight holding. Optionally, the grasping region may have a curve or bumps indicative of finger positioning. In some instances, the grasping region may have a rubbery or resilient layer or surface that may allow the user to comfortably grasp the handle.

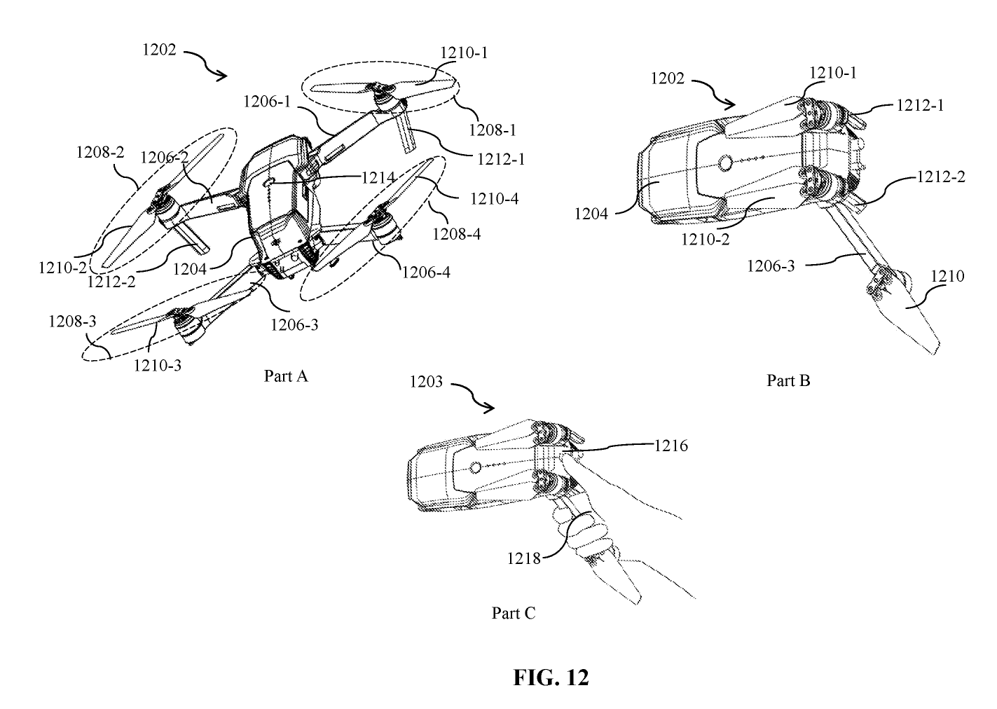

Alternatively, in some embodiments, the handle may be formed from one or more components of the transformable apparatus. For example, after folded downward, one or more arms supporting one or more propulsion units may be formed as a handle for user's holding, such as shown at the Part B of FIG. 1. In this manner, it is unnecessary to add an extra component as a handle. In some instances, the transformable apparatus may be ergonomically shaped for carrying by a single hand when in the handheld configuration. For example, the central body of the UAV may have an elongated shape (for example, hand-shaped) for easy holding by a single hand when in the second configuration. Additionally, one arm of the UAV may have an elongated shape (e.g., hand-shaped) for being held by a single hand of the user, as will be discussed with reference to FIG. 12.

The transformable apparatus may be configured such that the center of gravity of the transformable apparatus remains substantially above the handle or center of gravity of the handle, when the user is grasping the handle to operate the transformable apparatus in a handheld configuration. Alternatively, the center of gravity of the transformable apparatus may be substantially below or in line with the handle or center of gravity of the handle, when the user is grasping the handle to operate the transformable apparatus in a handheld configuration.

The handle may further comprise a user input interface 220 configured to receive an input from the user's hand while the user's fingers are at least partially wrapped around the grasping region. The input may include depression of one or more buttons, triggers, keys, joysticks, or trackballs, accessible by any of the user's thumb or fingers. The input may include a touchscreen or touchpad accessible by any of the user's thumb or fingers. The input received by the user input interface may effect operation of the UAV while the UAV is in the handheld configuration. In some instances, the user input may initiate the UAV to transform between a vehicle configuration and a handheld configuration. Additionally, the user input may comprise various control settings about one or more components of the UAV. For example, the control settings may be related to specific parameters with respect to components operating in the vehicle configuration or in the handheld configuration.

In one example, the user input may be used to control imaging performed by the apparatus when in the handheld configuration. For instance, the input may control positioning of an image capture device, actuation of a carrier, and/or zoom. In some instances where an image capture device, such as a camera, is coupled to the UAV, the user input may relate to various adjustable parameters of the camera. The adjustable parameter may comprise exposure (e.g., exposure time, shutter speed, aperture, film speed), gain, gamma, area of interest, binning/subsampling, pixel clock, offset, triggering, ISO, image capture modes (e.g., video, photo, panoramic, night time mode, action mode, etc.), image viewing modes, image filters, etc. Parameters related to exposure may control the amount of light that reaches an image sensor in the image capture device. For example, shutter speed may control the amount of time light reaches an image sensor and aperture may control the amount of light that reaches the image sensor in a given time. Parameters related to gain may control the amplification of a signal from the optical sensor. ISO may control the level of sensitivity of the camera to available light. Parameters controlling for exposure and gain may be collectively considered and be referred to herein as EXPO.

When the camera is coupled to the transformable apparatus via a carrier, for example, a gimbal, the user input may comprise settings or controls over the gimbal. In some instances, the gimbal may include one or more gimbal stages that may permit movement of the camera relative to the transformable apparatus. For instance, by manual setting or controlling, the gimbal may permit rotation of the camera relative to the transformable apparatus about at least one axis, for example, about one or more of a yaw axis, a roll axis and a pitch axis relative to the transformable apparatus. Any descriptions and/or characteristics of gimbals as described elsewhere in this specification may apply.

When in the handheld configuration, the transformable apparatus may be sized or balanced that may allow the user to easily hold and manipulate the transformable apparatus with a single hand. The transformable apparatus may support an image capture device and allow the user to control aim of the image capture device and/or operation of the image capture device, such as the parameters, with a single hand.

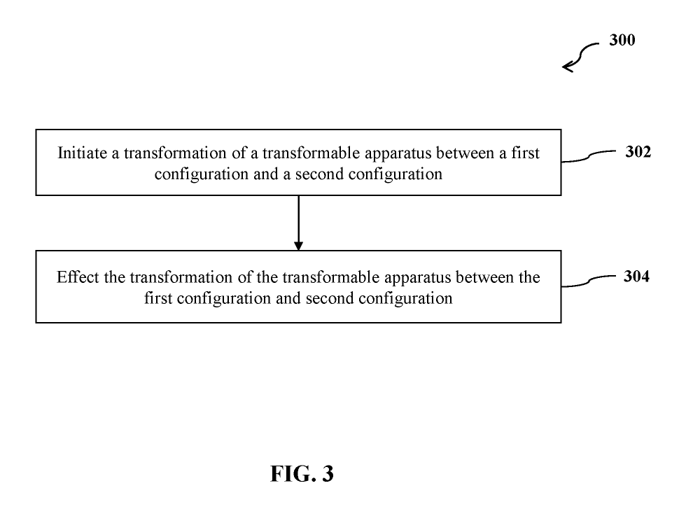

FIG. 3 shows a flow chart of a method 300 for effecting a transformation of a transformable apparatus, in accordance with embodiments of the disclosure. It is to be understood the transformable apparatus described in FIG. 3 may be the transformable apparatus as discussed above with reference to FIGS. 1 and 2 using the UAV as an example. Thus, any description about the transformable apparatus as described before or elsewhere in this specification may also be applied to the transformable apparatus as discussed in FIG. 3.

As illustrated in FIG. 3, at 302, the method 300 may initiate a transformation of a transformable apparatus between a first configuration and a second configuration. Optionally, the method may receive a user input to initiate the transformation of the transformable apparatus between the first configuration and the second configuration. As discussed before, in the first configuration, the transformable apparatus may be capable of self-propulsion with aid of one or more propulsion units. The transformable apparatus may be configured for aerial operation in the first configuration. Further, in the first configuration, the apparatus may function as a vehicle, such as an unmanned vehicle including, for example, an unmanned ground vehicle or an unmanned aerial vehicle, for performing a variety of tasks as described elsewhere in this specification. Therefore, the first configuration herein may be a vehicle configuration. Upon transforming from the first configuration to the second configuration, the transformable apparatus may be suitable for being held by a human hand. In the second configuration, the transformable apparatus may require manual manipulation for movement. Thus, the user may manually control the transformable apparatus as a handheld device for handheld operations, such as taking photos or recording a video using a camera attached to the transformable apparatus. Therefore, the second configuration herein may be a handheld configuration.

The method 300 may effect a transformation of the transformable apparatus between the first configuration and the second configuration at 304. Optionally, the transformation may be effected in response to the user input. In some embodiments, the user input may include manual manipulation of one or more components of the transformable apparatus. For instance, a user may manually move one or more components relative to another component to effect a transformation from a first configuration to a second configuration, or vice versa. The user may directly contact and manipulate one or more components to effect the transformation. In other instances, the user input may initiate one or more automated movements. For instance, a user may provide an input to an interaction assembly, which may cause one or more actuators to move one or more components without requiring direct user manipulation of that component. For instance, an indication of the user input may be received at one or more processors. In response to the indication of the user input, the one or more processors may generate an instruction to the actuator to move the one or more components. Alternatively, the transformation may occur without requiring a user input.

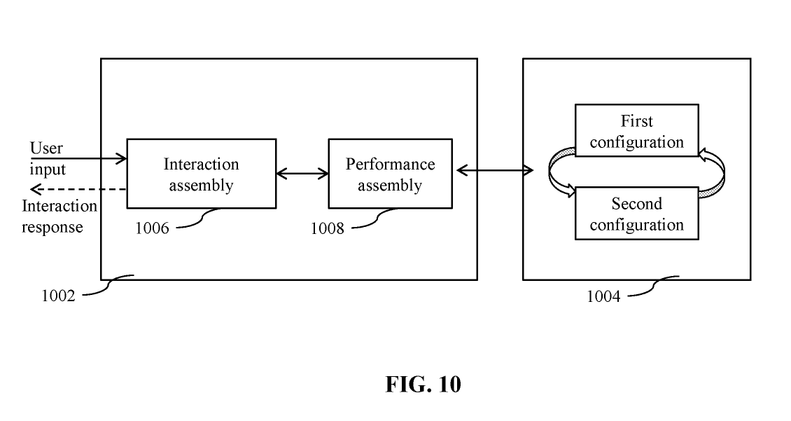

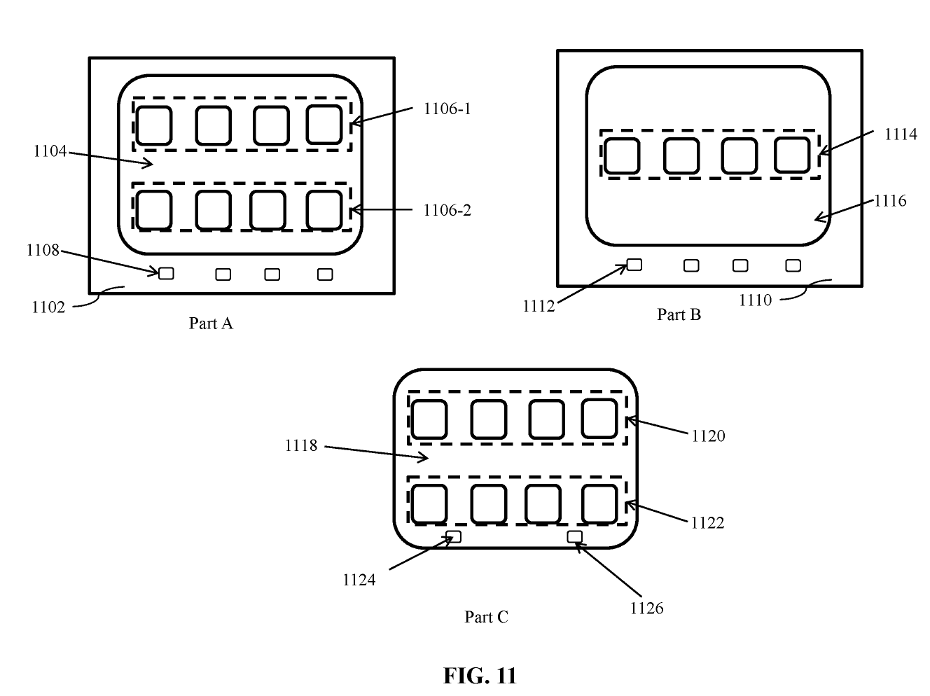

In some embodiments, the user input may be received with aid of an interaction assembly of a user interaction apparatus, as will be discussed in detail with reference to FIGS. 10 and 11. In some instances, the user may be able to select a desired configuration via the interaction assembly. For example, the user may select the handheld configuration since he or she wants to manually take some still images. Upon a selection of the handheld configuration, the transformable apparatus, which may be in the vehicle configuration, may automatically transform into the handheld configuration with aid of a performance assembly, as will be discussed in detail with reference to FIG. 10. For instance, the transformable apparatus may fold or retract one or more components thereof such that it transforms into the handheld configuration for user's holding. In some instances, the transformable apparatus, after transformed into the second configuration, may be used for handheld operations under the ground, in the underground pipelines, under the water or in a cave, for collecting environmental data, illumination, collecting samples, photography, etc.

As previously described, the transformable apparatus may transform between a first configuration and second configuration. The second configuration may optionally be a support apparatus that may support a payload, such as an image capture device. The support apparatus may be a tripod or stand for the image capture device. The support apparatus may optionally not be self-propelling. The support apparatus may be configured for ground level or lower operation. The support apparatus may be configured to rest on a surface to support the image capture device. The support apparatus may be configured primarily for stationary use, or may be carried on a movable object. The support apparatus may support an image capture device at a desired height without requiring support from additional devices. The support apparatus may optionally support the imaging at a greater height than the transformable apparatus would in the first configuration. For instance, a tripod may optionally support the imaging at a greater height than when in the first configuration. The support apparatus may or may not be handheld. For example, a stand for an image capture device may or may not be designed for handheld use. The support apparatus may or may not be capable of being carried in one hand. Alternatively, two hands may be needed to use or manipulate the support apparatus.

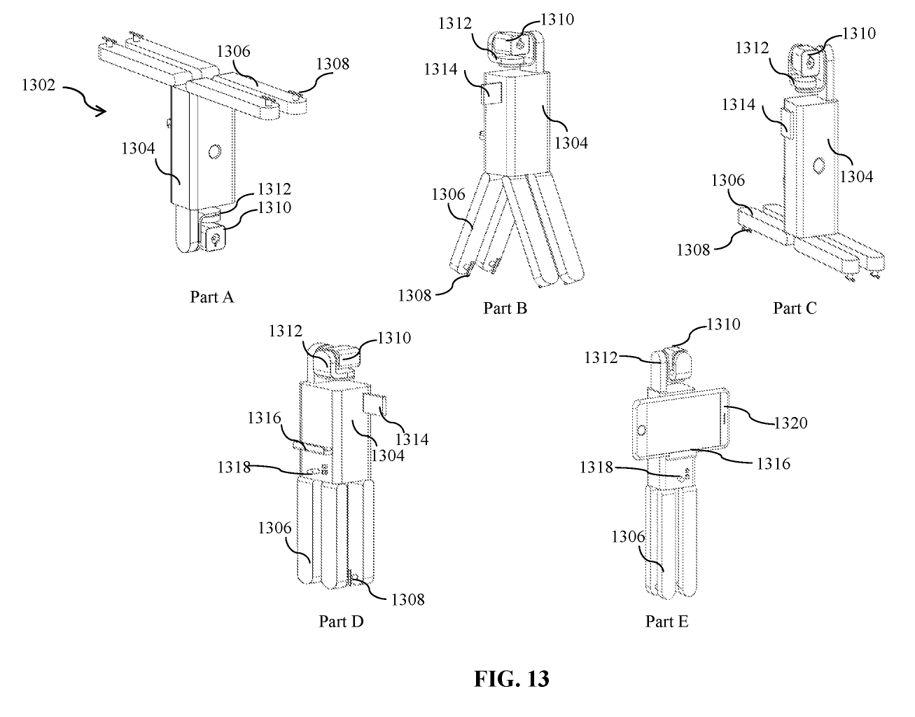

As discussed before, one or more components of the transformable apparatus may be folded or retracted as a handle for user's holding. However, in some instances, the one or more components of the transformable apparatus may be retracted or folded to form a leg of a support apparatus, such as a camera support device for supporting a camera. In some embodiments, the leg herein may be formed as a tripod for supporting the camera, for example, a tripod resting on a surface, as will discussed in detail with reference to FIG. 13. Thereby, the UAV may be able to rest on a surface (e.g., flat ground) or an object at orientation that permits effective operations in the second configuration. For example, after putting the camera onto the tripod, the user may be able to capture a still image or take self-portraits. This may be convenient to those users who use the transformable apparatus for the vehicle or aerial operations and then want to use it as a tripod for holding the camera so as to take photographs and make filming. Given the portability and availability, the length of one or more arms of the UAV may be selected such that the tripod formed from the folded arms may still be convenient for being held by the hand. For example, the length of the one or more arms may be 7 cm, 8 cm, 9 cm, 10 cm, 12 cm, 15 cm, 16 cm, 18 cm, 20 cm, 25 cm, 30 cm, or more. In some embodiments, the length of the arm may be a value in a range of 7 cm to 30 cm. The support apparatus may have any number of support legs. For example, two, three, four, five, six, seven, eight, or more support legs may be provided for a camera stand. In some instances, each leg of the support apparatus may correspond to an arm of a UAV that has been transformed to a leg.

After transforming from the first configuration to the second configuration, a transformable apparatus of the disclosure may transform from the second configuration back to the first configuration. The transformation from the second configuration to the first configuration may be the reverse of the transformation from the first configuration to the second configuration. For example, the folding or retracting operations performed in the transformation from the first configuration to the second configuration may be replaced with the unfolding or extending operations when performing the transformation from the second configuration to the first configuration.

In some embodiments, when a user desires to transform the transformable apparatus from a handheld device in the second configuration to a UAV in the first configuration, he or she may initiate the transformation of the transformable apparatus. The user may manually transform the transformable apparatus from the second configuration to the first configuration. In some instances, the user may manually unfold or extend one or more components of the transformable apparatus relative to another component of the transformable apparatus such that the transformable apparatus is transformed from the second configuration to the first configuration for vehicle operations, such as aerial operations. In an embodiment in which the one or more arms of the transformable apparatus are folded to form a handle when the transformable apparatus is in the second configuration, the user may manually unfold the one or more arms such that the transformable apparatus is in the first configuration.

Alternatively, the transformation of the transformable apparatus from the second configuration to the first configuration may be initiated in response to the user input. In some instances, the user may initiate one or more automated movements to effect the transformation. For example, the user may provide an input to an interaction assembly, which then may cause one or more actuators to move components such that the transformable apparatus transforms from the second configuration to the first configuration. An indication of the user input may be received at one or more processors on-board the transformable apparatus. In response to the indication of the user input, the one or more processors may generate an instruction to the one or more actuators at issue to move the one or more components. Thereby, the transformable apparatus may automatically transform from the second configuration to the first configuration. This is advantageous when the user using the transformable apparatus as a handheld device in the second configuration wants to use the transformable apparatus as a vehicle in the first configuration very soon without much manual intervention and waiting time.

The transformable apparatus may not perform the same tasks or missions in the first and second configurations. For example, the transformable apparatus may collect the weather data when in the first configuration and may collect samples on the ground in the second configuration. In some instances, the transformable apparatus may perform the same tasks or missions in both the first and second configurations.

For example, the transformable apparatus may perform imaging capture in both the first and second configurations. The imaging capture herein may be conducted in a continuous manner. For instance, the transformable apparatus may perform aerial or underwater photography in the first configuration through self-propulsion with aid of one or more propulsion units, and then may substantially immediately perform ground-level photography in the second configuration by user's manual manipulation. Further, the transformable apparatus may perform the imaging data transmission and data collection in both the first configuration and the second configuration. The transformable apparatus may be configured to capture images while transforming between the first and second configurations. This may allow for uninterrupted imaging while the transformable apparatus is transforming between the first and second configurations. Thus, the transformable apparatus may allow for aerial imaging to transform smoothly to handheld imaging without interruption, and vice versa.

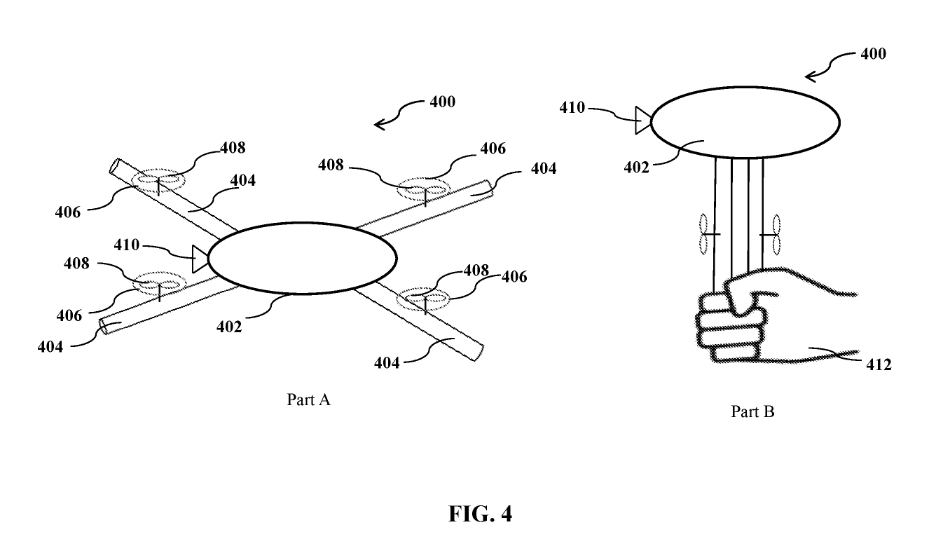

FIG. 4 provides an illustration of a transformable apparatus 400 performing image capturing in both a first configuration and a second configuration, in accordance with embodiments of the disclosure. It is to be understood the transformable apparatus depicted in FIG. 4 may be the transformable apparatus as discussed above with reference to FIGS. 1-3. Thus, any description about the transformable apparatus as described before may also be applied to the transformable apparatus as shown in FIG. 4. Any descriptions found elsewhere herein of the first configuration and second configuration of a transformable apparatus may apply to the transformable apparatus in FIG. 4.

As illustrated at Part A of FIG. 4, a transformable apparatus may be provided in a first configuration. One example of the first configuration is a UAV, which may include a UAV body 402 and one or more arms 404 extendable from the UAV body (e.g., central body) in the first configuration. One or more of the arms may support one or more propulsion units 406 that may effect flight of the UAV. The one or more propulsion units may carry one or more rotor blades 408. The rotor blades may be actuated by a motor or an engine to generate a lift force for the UAV. For example, the rotor blades may be affixed to a rotor of a motor such that the rotor blades rotate with the rotor to generate a lift force (thrust) for the UAV such that the UAV may be capable of performing aerial operations.

As shown at Part B of FIG. 4, the transformable apparatus is transformed into the second configuration. One example of a second configuration is a handheld configuration. In some embodiments, an apparatus may be transformed from a UAV to a handheld configuration upon folding the one or more arms downward as a handle for being held by a single hand 412. It is to be understood that folding the arms to form the handle is only illustrative of one way to transform the UAV into the second configuration. As previously noted, instead of using one or more arms as the handle, another component of the UAV may also be used for user's holding. For example, in some instances, foldable or retractable landing gears may be used as a handle after unfolded or extended out from the UAV body in the second configuration.

Further illustrated in FIG. 4 is an image capture device 410 for capturing images in both the first configuration and the second configuration. The image capture device (or imaging device) may be capable of detecting visible, infrared, or ultraviolet light. One or more image capture devices, such as cameras, may be provided on the transformable apparatus.

In some embodiments, the one or more image capture devices or the one or more interfaces to receive the one or more image capture devices are at a first position when the transformable apparatus is in the first (or vehicle) configuration and a second position different from the first position when the transformable apparatus is in the second (or handheld) configuration. For example, the one or more image capture devices may be at a first position relative to a central body in the first configuration, and the one or more image capture devices may be at a different second position relative to the central body in the second configuration. The image capture devices may have a primary orientation (e.g., pointing down) relative to the environment in the first configuration and a different second primary orientation (e.g., pointing forward) relative to the environment in the second configuration. Alternation between the first position and the second position may occur automatically with aid of one or more actuators. As an alternative, the alternation between the first position and the second position may occur manually. In some embodiments, the first position and the second position may be the same. For instance, the one or more image capture devices may remain stationary relative to the central body of the transformable apparatus during the transformation of the transformable apparatus between the first configuration and the second configuration.

The one or more image capture devices may be coupled to the transformable apparatus via one or more carriers configured to effect orientation of the one or more image capture devices. Any description herein of a carrier may include one or more gimbals, or vice versa. In some instances, the transformable apparatus may comprise one or more interfaces to receive the one or more gimbals. To control the one or more gimbals, the transformable apparatus may comprise a user interface and the one or more gimbals may be controlled by a user using the user interface. Alternatively or in addition, a user may control the gimbals from a device remote to the transformable apparatus. In some instances, a user may control a gimbal using a remote terminal when the transformable apparatus is in a first configuration (e.g., vehicle), and control the gimbal using a user interface on-board the transformable apparatus when the transformable apparatus is in a second configuration (e.g., handheld).

The image capture device as discussed above may include one or more cameras. A camera may be a physical image capture device. An image capture device can be configured to detect electromagnetic radiation (e.g., visible, infrared, and/or ultraviolet light) and generate image data based on the detected electromagnetic radiation. An image capture device may include an image sensor, such as a charge-coupled device (CCD) sensor or a complementary metal-oxide-semiconductor (CMOS) sensor that generates electrical signals in response to wavelengths of light. The resultant electrical signals can be processed to produce image data. The image data generated by an image capture device can include one or more images, which may be static images (e.g., photographs), dynamic images (e.g., video), or suitable combinations thereof. The image data can be polychromatic (e.g., RGB, CMYK, HSV) or monochromatic (e.g., grayscale, black-and-white, sepia). The image capture device may include a lens configured to direct light onto an image sensor.

The camera can be a movie or video camera that captures dynamic image data (e.g., video). A camera can be a still camera that captures static images (e.g., photographs). A camera may capture both dynamic image data and static images. A camera may switch between capturing dynamic image data and static images. Although certain embodiments provided herein are described in the context of cameras, it shall be understood that the present disclosure can be applied to any suitable image capture device, and any description herein relating to cameras can also be applied to any suitable image capture device, and any description herein relating to cameras can also be applied to other types of image capture devices.

A camera can be used to generate 2D images of a 3D scene (e.g., an environment, one or more objects, etc.). The images generated by the camera can represent the projection of the 3D scene onto a 2D image plane. Accordingly, each point in the 2D image corresponds to a 3D spatial coordinate in the scene. The camera may comprise optical elements (e.g., lens, mirrors, filters, etc). The camera may capture color images, greyscale image, infrared images, and the like.

The camera may capture an image or a sequence of images at a specific image resolution. In some embodiments, the image resolution may be defined by the number of pixels in an image. In some embodiments, the image resolution may be greater than or equal to about 352×420 pixels, 480×320 pixels, 720×480 pixels, 1280×720 pixels, 1440×1080 pixels, 1920×1080 pixels, 2048×1080 pixels, 3840×2160 pixels, 4096×2160 pixels, 7680×4320 pixels, or 15360×8640 pixels. In some embodiments, the camera may be a 4K camera or a camera with a higher resolution.

The camera may capture a sequence of images at a specific capture rate. In some embodiments, the sequence of images may be captured standard video frame rates such as about 24p, 25p, 30p, 48p, 50p, 60p, 72p, 90p, 100p, 120p, 300p, 50i, or 60i. In some embodiments, the sequence of images may be captured at a rate less than or equal to about one image every 0.0001 seconds, 0.0002 seconds, 0.0005 seconds, 0.001 seconds, 0.002 seconds, 0.005 seconds, 0.01 seconds, 0.02 seconds, 0.05 seconds. 0.1 seconds, 0.2 seconds, 0.5 seconds, 1 second, 2 seconds, 5 seconds, or 10 seconds. In some embodiments, the capture rate may change depending on user input and/or external conditions (e.g. rain, snow, wind, unobvious surface texture of environment).

The camera may have adjustable parameters. Under different parameters, different images may be captured by the image capture device while subject to identical external conditions (e.g., location, lighting). One or more cameras supported by the UAV may have one or more of the same parameters, characteristics or features. In some instances, all of the cameras supported by the UAV may have the same characteristics or features. Alternatively, one or more of the cameras supported by the UAV may have different characteristics or features. In some instances, each of the cameras supported by the UAV may have different characteristics or features.

A camera may be in operation while the transformable apparatus is in the first and second configurations, and optionally while transitioning between the first and second configurations. The camera may be powered on while the transformable apparatus in the first and second configurations, and optionally while transitioning between the first and second configurations. The camera may be capturing images while the transformable apparatus in the first and second configurations, and optionally while transitioning between the first and second configurations. The camera may be recording and/or transmitting images while the transformable apparatus in the first and second configurations, and optionally while transitioning between the first and second configurations. The camera may be stabilized while the transformable apparatus in the first and second configurations, and optionally while transitioning between the first and second configurations.

Based on the different configurations of the transformable apparatus, the user may configure the camera with different parameters as discussed above. One or more parameters of the camera may be adjusted when the transformable apparatus changes its configuration between the first and second configurations. For example, according to different user requirements or for different purposes, the camera parameters may be adjusted. In one example, the transformable apparatus may be a UAV performing aerial operations in the first configuration, and the camera may operate with a higher resolution than when the transformable apparatus is in a second configuration, such as a handheld configuration. In another example, a camera may operate with a higher frame rate when the transformable apparatus is in the first configuration, compared to the second configuration. In some instances, when the transformable apparatus is in the first configuration, the camera may take panoramic images, and when the transformable apparatus is in the second configuration, the camera may take regularly proportioned 2D images. In some instances, the camera may have a wider angle of image capture in the first configuration relative to the second configuration. Optionally, a camera may wirelessly transmit information in a different manner when the transformable apparatus is in a first configuration, as compared to a second configuration. The camera may consume a different amount of power when the transformable apparatus is in the first configuration, as compared to the second configuration. Optionally, different image stabilization techniques may be used between the first and second configurations.

Such adjustments to the parameters may occur automatically without requiring user intervention. In some embodiments, a transformation of the transformable apparatus may be detected, and may initiate the change of one or more camera parameters. Alternatively or in addition, the adjustments to the camera parameters may occur in response to one or more user instructions to change the one or more parameters. For instance, the user may adjust a camera parameter when the user changes configuration of the transformable apparatus. In some embodiments, a user may pre-set one or more camera parameters that may change when the transformable apparatus changes configurations. The camera parameters may be automatically adjusted upon transformation in accordance with the user's pre-sets.

In some embodiments, the camera may have the identical photographic parameters in both the first and second configurations of the transformable apparatus. The user may configure the camera to have the identical parameters. In this manner, the image, video, film, or footage made by the camera in both the first and second configurations may have the same image quality and visual effect, thereby achieving consistent visual experience.

The one or more cameras may be supported on a central body of a transformable apparatus. The transformable apparatus may be a UAV in a first configuration. The one or more cameras may be supported by a UAV body. The one or more cameras may or may not be supported on one or more arms of the UAV. The one or more cameras may be supported by a housing of the UAV. The one or more cameras may be attached to an external surface of the housing of the UAV. The one or more cameras may be embedded within an external surface of the housing of the UAV. The one or more cameras may have an optical element, such as a lens, that may be exposed to an environment exterior to the UAV. The optical element may optionally be protected from an environment exterior to the UAV with aid of a cover. The cover may be transparent. The cover may or may not include an optical filter.

In some embodiments, the camera may be coupled to the UAV in both the first and second configurations and can be configured in both configurations, for example, by the user in a wireless manner via a remote controller in the first configuration or in a wired manner in the second configuration. Alternatively, the camera may be coupled to the UAV in only one of the first configuration and second configuration, thereby performing the image capture in either of the first configuration and the second configuration.

As discussed before, although the UAV may perform image capturing in both the first configuration and the second configuration, some operations may be performed in only one of the first and second configurations. For example, in some embodiments, the aerial or vehicle operations, which may require self-propulsion, may be optionally performed only in the first configuration. In contrast, in some embodiments, the handheld operations, such as operations requiring user manual manipulations, may be optionally performed only in the second configuration. To this end, the transformable apparatus may comprise a handle which may be formed at least partially from an arm of the transformable apparatus. The handle may comprise a grasping region configured to permit a user's fingers to at least partially wrap around the grasping region.

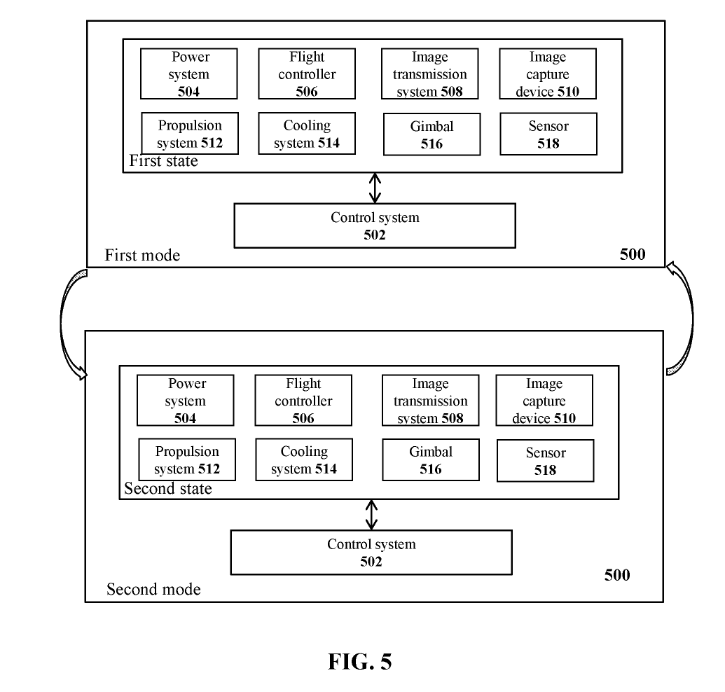

FIG. 5 provides an illustration of changes of functional operations of an apparatus 500 as the apparatus transforms between a first mode and a second mode, in accordance with embodiments of the disclosure. The apparatus as depicted in FIG. 5 may be an unmanned vehicle, such as an unmanned ground vehicle or an unmanned aerial vehicle (UAV) in the first mode. The apparatus may be capable of at least two modes, i.e., the first mode and second mode. The apparatus may functionally differently between the two modes. One or more functional units of the apparatus may function differently between the two modes. The apparatus may or may not have a physical transformation between the two modes. Changing between the first mode and second mode may or may not include a movement of one or more components of the apparatus relative to another component of the apparatus.

The apparatus may be configured to be capable of self-propulsion when in the first mode and may be configured to require manual manipulation for movement when in the second mode. Alternatively or additionally, the apparatus may be configured for aerial operation when in the first mode and may be configured for ground level or lower operation when in the second mode. In some embodiments, the apparatus may be a UAV capable of flight in the first mode and may be a handheld device configured to be carried ergonomically by a single hand when in the second mode. Any descriptions as made before or elsewhere in this specification with regard to the self-propulsion, manual manipulation, aerial operation, ground level and lower operation may also apply to the apparatus as discussed with reference to FIG. 5.

The apparatus may comprise a control system 502 and one or more functional units. As illustrated, the one or more functional units may comprise a power system 504, a flight controller 506, an image transmission system 508, an image capture device 510, a propulsion unit 512, a cooling system 514, a gimbal 516, and/or a sensor 518 as non-limiting examples. It should be noted that the functional units as depicted are only illustrative and there may be other functional units included in the apparatus which may be controlled by the control system.

The functional unit herein may comprise one or more of a software module, a hardware module, a component, a system, an element, a mechanism, or a member that are included in the apparatus or in connection with the apparatus such that it may provide certain functionality for the apparatus or enable the apparatus to have certain functionality.

The one or more functional units may comprise a power system. The power system may involve utilizing a variety of energy sources for providing electrical energy, magnetic energy, solar energy, wind energy, gravitational energy, chemical energy, nuclear energy, or any suitable combination thereof. The power system may provide power to the transformable apparatus. The power system may provide and/or regulate power to one or more functional units of the transformable apparatus. The power system may include an energy storage system. In some embodiments, the apparatus may comprise one or more battery units including rechargeable batteries for providing the electrical energy. The apparatus may optionally include an energy generation system. Thereby, the apparatus may be self-propelled via a propulsion system running on any of the above suitable energy. The power system may optionally comprise an energy converter or converting unit for converting one energy source into another energy source for powering the apparatus. For example, the apparatus may comprise a photoelectric transducer for converting the solar energy into the electrical energy.

The power system may optionally operate in a first state when the transformable apparatus is in a first mode, and a second state when the apparatus is in a second mode. The first state may be different from the second state. For example, the apparatus may be capable of self-propulsion in the first mode and may require manual manipulation for movement in the second mode. In such a case, the power supplied by the power system may be set differently for different modes. For example, the power system may be configured to provide more power for the apparatus in the first mode since the propulsion units may consume more energy in the first mode. Conversely, the power system may be configured to provide less power in the second mode than in the first mode since the user may manually move the apparatus and the power for driving the propulsion system may be reduced or even cut off. Therefore, the power consumption of one or more components of the apparatus may be reduced in the second mode relative to the first mode. This may advantageously save the power and increase the energy efficiency. In some instances, the power system may provide power to one or more propulsion units when the apparatus is in the first mode, and may cut off or prevent power from reaching the propulsion units when the apparatus is in the second mode. In alternative embodiments, the power system may operate the same way when the apparatus in the first and second modes.

The one or more functional units may comprise a flight controller. The flight controller may be supported by a body of the apparatus, for example, a UAV body, when the apparatus is implemented as a UAV. The flight controller may control one or more actuators on-board the apparatus. The flight controller may provide a signal that may affect the one or more actuators. The flight controller may comprise one or more processors that may generate the signal to affect the one or more actuators. The one or more processors may generate the signal in response to flight information. The signal may be generated on the flight controller or may be generated in response to a command from a user terminal remote to the apparatus. The signal may be generated in response to a signal from one or more sensors on-board the apparatus. The signal may be generated in response to vehicle operation data. The signal may be generated on the flight controller without requiring user input or active user control. In some embodiments, the flight controller may drive one or more propulsion units on-board the apparatus to generate a motion effect. The motion effect may include (1) a motion pattern of the apparatus, or (2) movement of the apparatus along a predetermined motion path. In some other embodiments, the apparatus may be autonomously operated using the flight controller on-board the apparatus.

The flight controller may optionally operate in a first state when the apparatus is in a first mode, and a second state when the apparatus is in a second mode. The first state may be different from the second state. In some embodiments, when the apparatus is in the first mode, the flight controller may control the propulsion system including one or more propulsion units to provide proper propelling forces for the apparatus to move; therefore, the flight controller is in the first state. When the apparatus is in the second mode, the flight controller may control the propulsion system to stop providing propelling forces for the apparatus to move; therefore, the flight controller is in the second state. For instance, when the apparatus is in the second mode, the flight controller may prevent the propulsion units from operating.

The one or more functional units may comprise an image transmission system. The image transmission system may transmit image data generated or collected by the apparatus. The image data may be generated or collected with aid of one or more image capture devices as previously discussed. The image transmission system may transmit the image data to a terminal device remote to the apparatus. The terminal device may be a remote controller. The remote controller may be the same as the one controlling the operation of the apparatus. Alternatively, the image transmission system may transmit the image data to a server, such as a cloud server for further processing. In addition to transmitting the image date, the image transmission system may also be capable of receiving image data or any other types of data from other components, elements, systems, or mechanisms on-board or off-board the apparatus. For example, the image transmission system may receive image data from the terminal device remote to the apparatus, process the image data and then transmit the processed image data back to the terminal device for use.

In some embodiments, the image transmission system may comprise a (first) communication unit on-board the apparatus. The first communication unit may be configured to receive encoded image or video data from an encoder on-board the apparatus, motion information from a motion controller on-board the apparatus, and/or environmental information from an environmental sensing unit on-board the apparatus. In some embodiments, the environmental information may be provided with the motion information from the motion controller to the first communication unit. In some instances, the first communication unit may be configured to transmit the encoded video data, motion information, and/or environmental information to a second communication unit remote to the apparatus. The second communication unit may or may not be located at a user terminal. The user terminal may or may not be located on the ground. The user terminal may be located remotely from the apparatus. In some instances, the second communication unit may be located at a ground station in communication with the apparatus and the user terminal. The user terminal and the apparatus may be in communication with each other via the communication unit and the second communication unit. The image data/information may be transmitted from the apparatus to the user terminal via a downlink. The user terminal or another apparatus may transmit various control signals to the apparatus via an uplink. Each of the uplink and the downlink may be a wireless link. The wireless link may include a RF (radio frequency) link, a Wi-Fi link, a Bluetooth link, a 3G link, or a LTE link. The wireless link may be used for transmission of image data or control data over long distances. For example, the wireless link may be used over distances equal to or greater than about 5 m, 10 m, 15 m, 20 m, 25 m, 50 m, 100 m, 150 m, 200 m, 250 m, 300 m, 400 m, 500 m, 750 m, 1000 m, 1250 m, 1500 m, 1750 m, 2000 m, 2500 m, 3000 m, 3500 m, 4000 m, 4500 m, 5000 m, 6000 m, 7000 m, 8000 m, 9000 m, or 10000 m.

The bandwidth of the communication between the apparatus and the user terminal (between the first and second communication units) may be in a range from about 10 Kbps to about 1M bps. Different image data compression strategies may be used depending on the current or available communication bandwidth. For example, whole images may be compressed uniformly when the communication bandwidth is fast enough to support real-time image transmission. However, when the communication bandwidth drops to a certain level, it may be switched to a different image compression strategy where different images are selectively compressed at different rates. In some embodiments, the encoded video data may comprise high-definition stereoscopic video data. In other embodiments, the processed video data may comprise ultra high-definition stereoscopic video data.

When the apparatus is in the first mode in which the apparatus may be self-propelled and perform vehicle operations including e.g., aerial operation as discussed before, the image transmission system may be configured to transmit the image data in a wireless manner to the user, particularly, a user terminal or a remote controller with a visual display. Therefore, the image transmission system may be in the first state at this moment. When the apparatus is in the second mode in which the apparatus may require the manual manipulation for movement, for example, being held by a user's hand, the image transmission system may be configured to transmit the image data in a wired manner since the user terminal may be in proximity to the apparatus and it may be easy to connect the user terminal and the apparatus using a cable including a coaxial-cable or a USB line. Therefore, the image transmission system may be in the second state at this moment. Since the image transmission system may be in the wired communication with the user terminal in the second state, the transmission power utilized for air interface and wireless communication with the terminal device in the first state may be saved. Thus, the image transmission system may operate at a reduced transmission power in the second mode relative to the first mode.

In some instances, when the apparatus is in the first mode in which the apparatus may be self-propelled and perform vehicle operations including e.g., aerial operation as discussed before, the image transmission system may be configured to transmit the image data using long-distance wireless communication techniques, including e.g., 2G, 3G, 4G cellular communication, satellite communication and the like. Correspondingly, the image transmission system may be in the first state. In some other instances, when the apparatus is in the second mode in which the apparatus may require the manual manipulation for movement, for example, being held by a user's hand, the image transmission system may be configured to transmit the image data using short-distance wireless communication techniques, including, e.g., ZigBee, Bluetooth, Wi-Fi, IrDA, Ultra Wide Band, NFC, DECT, wireless 1394, etc. Correspondingly, the image transmission system may be in the second state. Therefore, the image transmission system may be configured to operate with a shorter distance range in the second mode relative to the first mode. The shorter distance range may likely provide more stable or robust communication as compared to the long distance range, especially in the wireless communication due to the decrease of the communication distance. Further, the image transmission system may operate at a reduced transmission power in the second mode of the apparatus relative to the first mode of the apparatus since the shorter-distance wireless communication in the second mode may consume less transmission power as compared to the long-distance wireless communication in the first mode.

The one or more functional units may comprise one or more image capture devices, which may be received by one or more interfaces on-board the apparatus. The one or more image capture devices may be coupled to the apparatus via one or more carriers configure to effect orientation of the one or more image capture devices. The image capture device may comprise a camera, which may be a movie or video camera that captures dynamic image data (e.g., video). In some instances, a camera can be a still camera that captures static images (e.g., photographs). In some instances, a camera may capture both dynamic image data and static images. Alternatively, a camera may switch between capturing dynamic image data and static images. Any descriptions referring to the image capture device in relation to a transformable apparatus and different configurations may apply to the apparatus and different modes herein.

The one or more image capture devices may optionally operate in a first state when the apparatus is in the first mode and a second state when the apparatus is in the second mode. The first state may be different from the second state. For example, the image capture device may be configured to have a wider angle of image capture in the first state when the apparatus is in the first mode and may be configured to have a narrower angle of image capture in the second state relative to the first state when the apparatus is in the second mode. In some instances, the image capture device may be configured to capture and generate panoramic images in the first state when the apparatus is in the first mode and may be configured to capture and generate 2D images in the second state when the apparatus is in the second mode.

In some embodiments, the image capture apparatus may be configured to operate with a higher resolution in the first state when the apparatus is in the first mode than in the second state when the apparatus is in the second mode. Similarly, the image capture apparatus may be configured to operate with a higher frame rate in the first state when the apparatus is in the first mode than in the second state when the apparatus is in the second mode. Therefore, it is to be understood that different parameters or configurations can be set for the image capture devices for operating in the different states corresponding to different modes of the apparatus.

The one or more functional units may comprise one or more propulsion units. The one or more propulsion units may provide propulsive forces for the apparatus in the first mode. The one or more propulsion units may or may not provide propulsive forces for the apparatus in the second mode. Any descriptions of the one or more propulsion units made previously in relation to a transformable apparatus and different configurations may apply to the apparatus and different modes herein.

The one or more propulsion units may optionally operate in the first state when the apparatus is in the first mode and in the second state when the apparatus is in the second mode. For example, one or more rotor blades, shafts, or actuators of the propulsion units may change orientation to form the first state or second state when the apparatus is transformed between the first mode and/or the mode. The change in orientation of the propulsion units (or any components of the propulsion units as described) may be by any number of degrees, such as at least 30 degrees, 45 degrees, 60 degrees, 75 degrees, 85 degrees, 90 degrees, 95 degrees, 105 degrees, 120 degrees, 135 degrees, 150 degrees, or 165 degrees. The change in orientation of the propulsion units may be less than any of the values described or may fall within a range between any two of the values described. The change in orientation may be about a vertical angle. The change in orientation may include a vertical component. The change in orientation may include a component that is in a direction parallel to the direction of gravity. As discussed before, in some embodiments, the propulsion units may be powered on and thereby in the first state when the apparatus is in the first mode. In contrast, the propulsion units may be powered off and thereby in the second state when the apparatus is in the second mode. Therefore, the propulsion units may be configured to have a higher power level in the first state when the apparatus is in the first mode as compared to the second state when the apparatus is in the second mode. Alternatively, the propulsion units may be configured to remain stationary in the second state even if the user accidentally powers on the propulsion units. Therefore, the functionality of the propulsion units may be completely disabled in the second state when the apparatus is in the second mode for handheld operations.

The rotor blades of the propulsion units may be unfolded or untucked in the first state when the apparatus is a UAV in the first mode and may be folded or tucked in the second state when the apparatus is a handheld device in the second mode. Alternatively, the propulsion units or the rotor blades thereof may be mounted or attached to the apparatus in the first state when the apparatus is a UAV in the first mode and may be removed or released from the apparatus in the second state when the apparatus is a handheld device in the second mode.

The one or more functional units may comprise a cooling system configured to cool and maintain one or more components of the apparatus within a specified temperature range so as to optimize the performance and operational life of the apparatus. In some instances, the cooling system may comprise one or more fans to generate airflow to transfer heat generated by the components on-board the apparatus, for example, the heat generated by the propulsion units.

The cooling system may optionally operate in a first state when the apparatus is in the first mode and in a second state when the apparatus is in the second mode. The first state may be different from the second state. For example, when the apparatus is in the first mode, the cooling system may be powered with a high power level so as to cool the propulsion units or other components or assemblies involved in the aerial operations. As compared thereto, when the apparatus is in the second mode, the cooling system may be powered with a relatively low power level relative to the first mode since the propulsion units in the second mode may be shut down or operate with low power. In some instances, the cooling system may cool different components of the apparatus when in the different modes. For example, when the apparatus is in the first mode, the cooling system may cool the propulsion units in the first state. When the apparatus is in the second mode, the cooling system may not cool the propulsion units in the second state.

The one or more functional units may comprise a gimbal configured to effect orientation of an image capture device. The gimbal may be removably connected to the apparatus. The gimbal may be directly connected to the apparatus or indirectly via any suitable coupling elements or mechanisms. The gimbal may be configured to drive the image capture device to rotate about one or more axes, such as at least one of a roll axis, a yaw axis, and a pitch axis. The gimbal may include one or more motors for rotating the image capture device in various directions such that the image capture device may capture the images at different orientations.

The gimbal may optionally operate in a first state when the apparatus is in the first mode and in a second state when the apparatus is in the second mode. The first state may be different from the second state. In some embodiments, a first set of rules to control orientation is applied by the gimbal in the first mode and a second set of rules to control orientation different from the first set of rules is applied by the gimbal in the second mode. In other words, the apparatus in different modes may render the gimbal in the corresponding different states. For example, regarding the first set of rules, the user may set a number of threshold rotation angles for the gimbal such that a field of view of the image capture device coupled to the gimbal may not be obstructed by other components of the apparatus, such as propellers or landing gears when the apparatus is embodied as a UAV and perform aerial operations. Regarding the second set of rules, the user may set a number of different threshold rotation angles for the gimbal since the apparatus may be held by the user's hand for shooting and can be manually controlled. The first and second sets of rules may be input by a user through a user interface on the apparatus. Additionally, the user interface may comprise one or more of a button, a switch, a dial, a touchscreen, a slider, a knob, or a key for user input.

For instance, when the apparatus is in the first mode, the user may configure maximum rotating angles of the gimbal in each of a roll axis, a yaw axis and a pitch axis relative to the apparatus such that the landing gears or propellers may not be present in the images captured by an image capture device coupled to the gimbal in the first state. When the apparatus is in the second mode, the user may configure different rotating angles of the gimbal in each of a roll axis, a yaw axis and a pitch axis in the second state than in the first state. Due to different grasping positions of the apparatus in the second mode or the orientation changes of the apparatus in the second mode, the landing gears or propellers may not obstruct a field of view of the image capture device coupled to the gimbal in the second state. Similarly, when the apparatus is in the first mode, the user may configure maximum rotating angles of the gimbal in various directions in the first state such that images captured by an image capture device coupled to the gimbal can be used for generating a panoramic image. When the apparatus is in the second mode, the user may configure different rotating angles of the gimbal in the second state relative to the first state since he or she may desire to take normal images or 2D pictures rather than the panoramic image.

In some instances, the gimbal may be capable of stabilizing the image capture device to equipoise an external force exerted on the image capture device in a substantially horizontal direction in the first mode and a gravity force of the image capture device in a substantially vertical direction in the second mode. For example, when the apparatus is a UAV in the first mode and the gimbal is movably coupled to the UAV, the gimbal may provide the support for the image capture device in the horizontal direction to counteract the external force exerted on the image capture device. For example, the external force may be wind-force. When the apparatus at issue is in the second mode, the gimbal may support the image capture device in the vertical direction, for example, positioned beneath the image capture device, then the support force from the gimbal may equipoise the gravity force of the image capture device in the vertical direction. The image capture device may be held by the gimbal at different or same orientations relative to a central body of the apparatus in different modes. Additionally, the image capture device may be held at the same orientation relative to an environment, which may cause it to be at different orientations relative to the central body of the apparatus in different modes.

The one or more functional units may optionally comprise one or more sensors configured to sense surrounding environments, spatial locations, velocity, and/or acceleration of the apparatus, collect various types of data and the like. Examples of sensors on the apparatus (which may be within the housing, outside the housing, embedded in the housing, or any combination thereof) may include one or more of the following: a global positioning system (GPS) sensor, a vision sensor, a temperature sensor, a lidar sensor, an ultrasonic sensor, a barometer, or an altimeter. Any sensor suitable for collecting environmental information can be used, including location sensors (e.g., GPS sensors, mobile device transmitters enabling location triangulation), vision sensors (e.g., image capture devices capable of detecting visible, infrared, or ultraviolet light, such as cameras), proximity sensors (e.g., ultrasonic sensors, lidar, time-of-flight cameras), inertial sensors (e.g., accelerometers, gyroscopes, inertial measurement units (IMUs)), altitude sensors, pressure sensors (e.g., barometers), audio sensors (e.g., microphones) or field sensors (e.g., magnetometers, electromagnetic sensors). Any suitable number and combination of sensors can be used, such as one, two, three, four, five, or more sensors.

The sensor may optionally operate in a first state when the apparatus is in the first mode and in a second state when the apparatus is in the second mode. For example, when the apparatus is in the first mode for e.g., aerial operations, the GPS sensor may operate in the first state at its full power or capability with highest possible precision. However, when the apparatus is in the second mode for ground or lower level operations, e.g., for handheld operations, the GPS sensors may be switched off in the second state since the GPS sensors may not be needed for location positioning in the second mode. Similarly, the altitude sensors may be switched on in a first state when the apparatus is in the first mode and may be switched off in a second state when the apparatus is in the second mode. Since the apparatus may perform the aerial operations in the first mode and perform ground or lower level operation in the second mode, different parameters for the one or more sensors operating in the different states may be configured. For example, the vision sensors may be configured for panoramic imaging in the first state when the apparatus is in aerial operations in the first mode and configured for 2D imaging in the second state when the apparatus is in handheld operations in the second mode.

The control system may be configured to control the one or more functional units to transform between the first state and the second state as the apparatus changes between the first mode and the second mode. For instances, when the control system detects that mode change occurs to the apparatus, it may permit the one or more functional units to accordingly change their states. In some embodiments, the control system may effect operation of the one or more functional units in response to an external input. The external input may be generated from a user terminal remote to the apparatus. The external input may be initiated by a user. The external input may be conducted by interacting with the apparatus from the outside.

In some instances, the external input may be provided via a state-switching interface or a mode-switching interface on-board or off-board the apparatus. The state-switching interface or the mode-switching interface may be a button, switch, dial, touchscreen, slider, knob, or key. The mode of the apparatus may be changed by touching, pressing or selecting the mode-switching interface on the apparatus. The states of the one or more functional units may be changed by touching, pressing or selecting the state-switching interface on the apparatus. The external input may be provided by a user terminal (or terminal device) remote to the apparatus or in proximity to the apparatus.

For example, the user may select a desired mode of the apparatus via the mode-switching interface on the terminal device and a signal indicative of the selected mode may be transmitted wirelessly to the apparatus, which may enable the apparatus to operate in the selected mode. Similarly, the user may select desired states of the functional units via the state-switching interface on the terminal device and a signal indicative of the selected states may be transmitted wirelessly to the apparatus, which may enable the functional units to operate in the selected states. Alternatively, the external input may be provided by the terminal device in a wired connection with the apparatus. For example, the terminal device may be connected to the apparatus via any suitable cable and the user may select physical or virtual items arranged on the terminal device and indicating different modes (or different states of the functional units). Thereafter, a signal indicative of the selected mode (or state) may be generated and transmitted to the apparatus from the terminal device via the cable, which leads the apparatus (or the functional units) to operate in the selected mode (or in the selected state).

In some instances, the external input may be provided by a gesture or voice command from a user of the apparatus. For example, when the apparatus is outfitted with a voice recognition device or an image recognition device, a specified gesture or voice made by the user may be identified by the voice recognition device or the image recognition device as a mode-switching or state-switching instruction. As a consequence, the control system may change the mode of the apparatus or the state of the functional units based on the recognition. For example, if the user says “enter into the first mode,” the apparatus with the voice recognition device may record the voice and verify the authenticity of the user by e.g., comparing the currently-recorded voice with the previously-stored voice. If two sounds are matched to each other, then the control system may allow the apparatus to operate in the first mode for, e.g., aerial operations. In response thereto, the one or more functional units may also change or enter into their first states. For example, the GPS sensors or altitude sensors may be switched on in the first state when the apparatus is about to operate in the first mode.

Additionally or alternatively, the external input may be provided by a change in orientation of the apparatus initiated by a user. In some instances, by changing the orientation of the apparatus towards a specified direction, the apparatus may automatically change its mode between the first mode and the second mode and the one or more functional units may accordingly change its state between the first state and the second state. For example, with aid of one or more inertial measurement units (IMUs) or similar units on-board apparatus, the apparatus may determine its own orientation relative to a reference coordinate system. When detecting that its central body is rotated by a certain degrees, e.g., 180 degrees, the apparatus may determine that it should enter into a different mode, e.g., from a first mode for aerial operation to a second mode for ground level or lower operations.

In some embodiments, the control system may effect operation of the one or more functional units in response to internal input. The internal input may be any instructions or data generated or collected from one or more components on-board or inside the apparatus. Based on the collected internal data, the control system may automatically change the mode of the apparatus or state of the one or more functional units without requiring external input or external signals. The control system may change the mode of the apparatus or state of the one or more functional units based on the collected internal data in combination with the external input or signals. For example, the control system may ask for user's permission of the mode or state change via a user interface after the control system determines that the mode or state change is necessary based on the collected internal data. In some embodiments, the internal data may optionally comprise sensor data or vehicle operation data.

The sensor date may be any data that can be sensed, generated or collected by one or more sensors on-board the apparatus. One or more sensors on-board the apparatus may sense the spatial disposition, velocity, and/or acceleration of the apparatus (e.g., with respect to up to three degrees of translation and up to three degrees of rotation). The one or more sensors can include global positioning system (GPS) sensors, motion sensors, vision sensors, inertial sensors, proximity sensors, image sensors, altitude sensor, pressure sensors, audio sensors, field sensors, acceleration sensor, etc. In some instances, the apparatus may initiate a mode change based on information from one or more sensors on-board the apparatus. For example, the altitude sensors may gather information indicative of the apparatus altitude relative to an underlying surface. The control system may cause the apparatus to transform from the first mode to the second mode when the altitude sensors detects that the apparatus is at or beneath a predetermined altitude relative to the underlying surface. Thereby, the one or more functional units of the apparatus may change accordingly from the first state to the second state.

As another example, the acceleration sensor may detect the acceleration of the apparatus in different modes. When the acceleration sensor senses that the acceleration of the apparatus is equal to or greater than a predetermined threshold, it may generate corresponding sensor data to instruct the control system to change the mode of the apparatus or the state of the functional units from the second mode to the first mode, or from the second state to the first state. Similarly, when the acceleration sensor senses that the acceleration of the apparatus is equal to or less than a predetermined threshold, it may generate corresponding sensor data to instruct the control system to change the mode of the apparatus or the state of the functional units from the first mode to the second mode, or from the first state to the second state.

In some instances, the control system may monitor vehicle operational data of the apparatus and use the vehicle operational data to effect the operation of the one or more functional units. For example, the control system may obtain the vehicle operational data about the propulsion units from the flight controller. The flight controller may communicate with and/or control operation of the one or more propulsion units with aid of one or more electronic speed control (ESC) modules. Based on the vehicle operational data about the propulsion units, for example, the data about rotation speed of the propellers and the power consumption of the motor, the control system may determine whether to change the state of the propulsion units from the first state to the second state or vice versa, as shown by arrows in FIG. 5.

As another example, a power level of the propulsion units may be monitored by the power system. When the power level is equal to or greater than a predetermined threshold, the power system may indicate the control system to change the mode of the apparatus from the second mode to the first mode, or change the state of the functional units from the second state to the first state. Similarly, when the power level is equal to or less than a predetermined threshold, the power system may indicate the control system to change the mode of the apparatus from the first mode to the second mode, or change the state of the functional units from the first state to the second state. In an alternative embodiment, when the propulsion units are shut down or powered off, the control system may change the mode of the apparatus from the first mode to the second mode, or change the state of the functional units from the first state to the second state. In contrast, when the propulsion units are powered on, the control system may change the mode of the apparatus from the second mode to the first mode, or change the state of the functional units from the second state to the first state.

It is to be understood that the mode change of the apparatus in some embodiments may cause the control system to change the state of the one or more functional units accordingly. Alternatively, the state change of the one or more functional units may cause the control system to change the mode of the apparatus between the first mode and the second mode.

In order for better control of the apparatus and one or more functional units arranged thereon, a user interface may be provided for the user. The user interface may be on-board the apparatus. For example, the user interface may be arranged on the body of the apparatus, e.g., on the UAV body or the central body when the apparatus is implemented as a UAV in the first mode. The user interface may comprise one or more of a button, a switch, a dial, a touchscreen, a slider, a knob, or a key. The user interface may comprise the state-switching interface or the mode-switching interface as discussed before. The user interface, when embodied as a touch sensitive screen, may comprise a number of graphic objects or options for controlling and setting the one or more functional units as discussed above or elsewhere in this specification. In some implementations, different graphic objects may be displayed when the apparatus in a different mode and the one or more functional units in a different state. In some implementations, all the graphic objects may be displayed on the screen regardless of the mode or state that the apparatus or the one or more functional units are in. In some instances, different setting or control pages for different functional units may be displayed on the screen and the user may search for the desired functional unit and make corresponding configurations by turning to the matched page via a finger. In some embodiments, the user interface may comprise graphic objects for controlling the gimbal such that the image capture device coupled to the gimbal is driven to rotate about one or more axes relative to the apparatus.

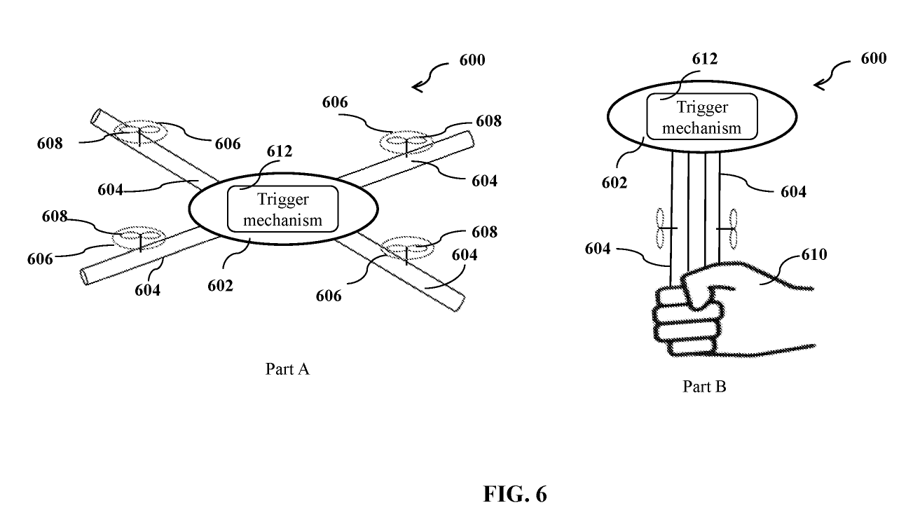

FIG. 6 provides an illustration of a trigger mechanism for triggering a transformation of a transformable apparatus, in accordance with embodiments of the disclosure. A trigger mechanism may be configured to initiate a transformation of the transformable apparatus between a first configuration and a second configuration. One example of the first configuration may be a vehicle configuration. One example of the second configuration may be a handheld configuration. When in the vehicle configuration, the transformable apparatus may be any vehicle, such as an unmanned vehicle including an unmanned ground vehicle and an unmanned aerial vehicle (UAV). When in the handheld configuration, the transformable apparatus may be a handheld device configured to be held by a human hand. Any descriptions of a transformable apparatus made before or elsewhere in this specification may apply to the transformable apparatus as discussed with reference to FIG. 6.

As illustrated at Part A of FIG. 6, a transformable apparatus 600 in the vehicle configuration, may be a UAV. The UAV may include a UAV body 602 and one or more arms 604 extendable from the UAV body (e.g., central body) when the transformable apparatus is in the vehicle configuration. One or more of the arms may support one or more propulsion units 606 that may effect flight of the UAV. The one or more propulsion units may carry one or more rotor blades 608. The rotor blades may be actuated by a motor or an engine to generate a lift force for the UAV. For example, the rotor blades may be affixed to a rotor of a motor such that the rotor blades rotate with the rotor to generate a lift force (thrust) for the UAV. Thereby, the UAV may be capable of performing vehicle operations in a self-propulsion manner, such as aerial operations, for example, collection of environmental data, aerial photography, aerial surveillance, aerial survey, real-time image transmission, etc.

As mentioned before, a trigger mechanism may be used for transforming the transformable apparatus between the first (e.g., vehicle) configuration and the second (e.g., handheld) configuration. The trigger mechanism herein may be a single trigger mechanism for transforming the transformable apparatus between the first configuration and the second configuration. Alternatively, the trigger mechanism may include a first trigger mechanism and a second trigger mechanism, wherein the first trigger mechanism may be used for transforming the transformable apparatus from the first configuration to the second configuration, and the second trigger mechanism may be used for transforming the transformable apparatus from the second configuration to the first configuration. In some embodiments, the trigger mechanism may comprise multiple potential triggers, which may be of the same type or different types.

The trigger mechanism may be configured to cause movement of one or more components of the transformable apparatus relative to another component of the transformable apparatus. The trigger mechanism may be configured to initiate the movement of the one or more components with aid of one or more actuators. For example, the trigger mechanism may generate a signal indicative of a trigger and send it to a processor. Upon receipt of such a signal, the processor may generate instructions to instruct the one or more actuators to actuate the one or more components such that the one or more components may move relative to the other component. Thereby, the transformable apparatus may be transformed between the first configuration and the second configuration. It is to be understood that movement of the one or more components may be automatically effected in response to the trigger mechanism with aid of one or more actuators.

One or more components of the transformable apparatus may move relative to a central body or region of the transformable apparatus. Movement of the one or more components of the transformable apparatus may include a rotation about one or more of a yaw, pitch, or roll axis of the transformable apparatus. When multiple components are movable, they move rotationally and/or translationally with respect to the same one, two, or three axes, or different axes. Movements may include pivoting, folding, sliding, telescoping, or any combination thereof, during transformation. In some embodiments, the one or more components may include a component that supports a propulsion unit of the transformable apparatus, such as an arm or leg. Any descriptions regarding the movement of the one or more components made before or elsewhere in this specification may apply to the movement of the one or more components as discussed with reference to FIG. 6.

As shown at Part B of FIG. 6, with aid of a trigger mechanism 612, the transformable apparatus in the vehicle configuration is transformed into the handheld configuration upon moving or folding the one or more arms downward as a handle for being held by a single hand 610. In the handheld configuration, the transformable apparatus may function as a handheld device for being held by user for handheld operations, such as ground level or lower operations. For example, when a camera is attached to the transformable apparatus, the user may directly take picture or make video using the transformable apparatus as a handheld image capture device. In the lower operations, the user may use the transformable apparatus in the handheld configuration as a camera support device for supporting or holding the camera for shooting. It can be understood that the transformable apparatus may perform the image capture with aid of the camera in both the vehicle configuration and the handheld configuration.

Instead of using one or more arms that support propulsion units as the handle, another component of the transformable apparatus may be used for user's holding. For example, in some instances, foldable or retractable landing gears may be used as a handle after folded or extended out from the UAV body in the handheld configuration. In some embodiments, the transformable apparatus may comprise a handle ergonomically designed to be carried by a single hand when in the handheld configuration. For example, a handle or handle-like component may be retracted into the UAV body when the transformable apparatus is in the vehicle configuration. Upon initiation of the trigger mechanism, the handle or handle-like component may be extended out of the UAV body in the handheld configuration for user's holding. The handle may be designed to have a grasping region configured to permit a user's fingers to at least partially wrap around the grasping region where a user input interface may be disposed for receiving an input from the user's hand. Alternatively, the transformable apparatus may be ergonomically shaped for carrying by a single hand when in the handheld configuration.

In some embodiments, the transformable apparatus may further comprise a user interface for receiving a user input to control operations of one or more functional units, wherein the one or more functional units are selected from a group comprising a power system, a flight controller, an image transmission system, a propulsion system, a cooling system, a gimbal, an image capture device or one or more sensors, similar to those schematically illustrated in FIG. 5. The input received by the user input interface may effect operation of the transformable apparatus while the transformable apparatus is in the handheld configuration. In some instances, the user input may control a gimbal such that the image capture device coupled to the gimbal is driven to rotate about one or more axes, including a roll axis, a yaw axis, or pitch axis relative to the transformable apparatus. Any descriptions of functional units made before or elsewhere in this specification may apply to the functional units as discussed herein.

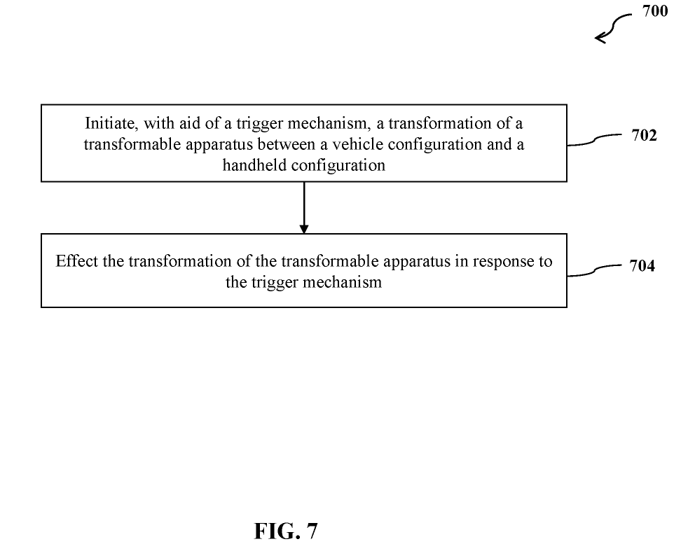

FIG. 7 shows a flow chart of a method 700 for operation of a transformable apparatus with aid of a trigger mechanism, in accordance with embodiments of the disclosure. The trigger mechanism as described in FIG. 7 may be the trigger mechanism as shown in FIG. 6. Therefore, any descriptions of the trigger mechanism as made before with reference to FIG. 6 may apply to the trigger mechanism as discussed below with reference to FIG. 7. It is to be understood that the method 700 may implement the operations as discussed above with reference to FIG. 6.

As illustrated FIG. 7, at 702, the method may initiate, with aid of a trigger mechanism, movement of one or more components of the transformable apparatus such that the transformable apparatus is transformed between a vehicle configuration and a handheld configuration. As previously discussed, in the vehicle configuration, the transformable apparatus may be any vehicle including ground vehicles or aerial vehicles, such as a UAV. Further, the transformable apparatus may be permitted to be self-propelled with aid of one or more propulsion units in the vehicle configuration. Additionally, the transformable apparatus in the vehicle configuration may be capable of aerial operations, e.g., aerial photography. When in the handheld configuration, the transformable apparatus may be incapable of self-propulsion. Therefore, the transformable apparatus may be propelled with aid of external means. For example, the transformable apparatus may be attached to a moving object, such as a bike, a car, or a boom, so as to get propelled. Alternatively, the transformable apparatus may be carried, held, or grasped by user's hand in the handheld configuration.

The transformable apparatus may be a handheld device in the handheld configuration and may be held by a single hand or two hands of the user. The transformable apparatus in the handheld configuration may perform ground level or even lower operations. For example, the user may use the transformable apparatus as a handheld image capture device (or a handheld imaging device) when an image capture device is attached to the transformable apparatus. In such a case, the user may hold a handle of the transformable apparatus formed from one or more components of the transformable apparatus to take photos or record video. Alternatively, the user may mount a separate handle to the transformable apparatus and grasp the separate handle to make footage. In some instances, the transformable apparatus may comprise a handle ergonomically designed to be carried by a single hand when in the handheld configuration.

The trigger mechanism may initiate physical transformation of the transformable apparatus. For example, the trigger mechanism may initiate one or more components of the transformable apparatus to move relative to another component of the transformable apparatus. The other component may be a central body or a region of the transformable apparatus. In some embodiments, the one or more components may be moveably connected via a connecting mechanism. The connecting mechanism herein may comprise any suitable mechanical mechanisms, elements, components, member, such as a chaining mechanism, a linkage mechanism, an actuator mechanism, a locking mechanism, a quick release mechanism, screws, bolts, fastener, elastic elements, hooks, belts, chains, and the like. The movement of one or more components may include rotating about one or more of a yaw, pitch or roll axis of the transformable apparatus. Movements may include pivoting, folding, sliding, telescoping or any combination thereof.

In some embodiments, the trigger mechanism may also initiate state changes of one or more functional units. The functional units herein may be selected from a group comprising a power system, a flight controller, an image transmission system, a propulsion system, a cooling system, a gimbal and an image capture device. The trigger mechanism may initiate one or more functional units to operate in a first state when the transformable apparatus is in the vehicle configuration and operate in a second state different from the first state when the transformable apparatus is in the handheld configuration. Any descriptions of the state changes as discussed before with reference to FIG. 5 may also apply to the state changes as discussed herein.

The physical transformation of the transformable apparatus may trigger the state changes of the one or more functional units of the transformable apparatus. Conversely, the state changes of the one or more functional units of the transformable apparatus may trigger the physical transformation of the transformable apparatus. In an alternative embodiment, the state changes of the one or more functional units and the transformation of the UAV may occur at the same time. Optionally, as soon as the transformable apparatus completes its physical transformation between the vehicle configuration and the handheld configuration, the one or more functional units may start to change its state to adapt to the current configuration of the UAV. Additionally, in some embodiments, when the one or more functional units change their states, the trigger mechanism may be triggered to initiate the transformation of the UAV between the vehicle configuration and the handheld configuration.

At 704, the method may effect a transformation of the transformable apparatus between the vehicle configuration and the handheld configuration in response to the trigger mechanism.

The transformation of the transformable apparatus between the vehicle configuration and handheld configuration may be conducted automatically in response to a trigger of the trigger mechanism. For example, the trigger mechanism may generate an instruction or a signal indicative of movement of one or more components of the transformable apparatus and send it to a processor. Upon receiving the instruction or the signal, the processor may direct one or more actuators to actuate the one or more components to move, thereby transforming the transformable apparatus between the vehicle configuration and the handheld configuration. In some implementations, the trigger mechanism may directly communicate with the one or more actuators associated with one or more components and instruct the actuators to actuate the relevant components so as to transform the transformable apparatus into the expected configuration.

In some instances, the trigger mechanism may be omitted from the transformable apparatus. In this case, the transformation of the transformable apparatus may be carried out by manual operations. For example, the user may manually move one or more components of the transformable apparatus in predetermined directions such that the transformable apparatus may be in an expected configuration. In some instances, when the one or more components of the transformable apparatus are one or more arms, the user may manually fold or retract the one or more arms such that the transformable apparatus may be in the handheld configuration. Conversely, the user may manually unfold or extend the one or more arms such that the transformable apparatus may be in the vehicle configuration. In some embodiments, the user may directly remove some components from the transformable apparatus or mount some components to the transformable apparatus such that the transformable apparatus may be in the different configurations. For instance, the user may manually remove the arms such that the transformable apparatus is in the handheld configuration. Conversely, the user may manually add the arms back to the transformable apparatus such that the transformable apparatus may be in the vehicle configuration.

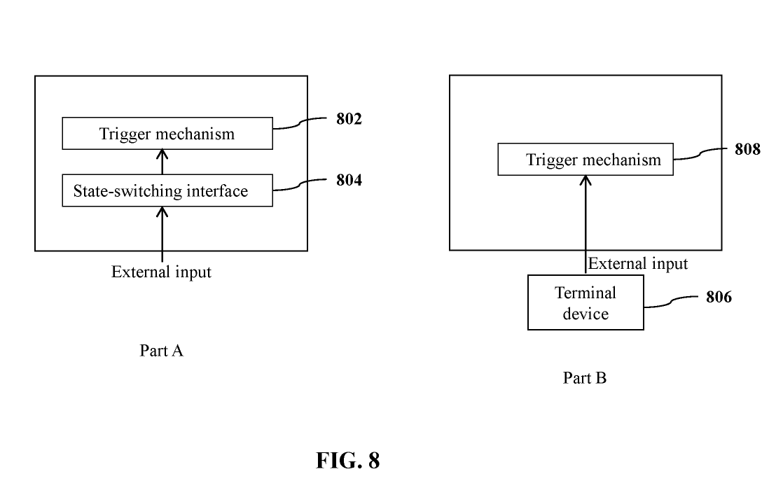

A trigger mechanism may respond to external input. FIG. 8 provides an illustration of different types of external inputs to a trigger mechanism, in accordance with embodiments of the disclosure. The trigger mechanism as illustrated in FIG. 8 may share one or more characteristics, features, components with the arrangement and methods as described with reference to FIGS. 6 and 7. Optionally, the trigger mechanism as illustrated in FIG. 8 may be identical to the trigger mechanism as discussed in FIGS. 6 and 7.

As shown at Part A of FIG. 8, a trigger mechanism 802 may initiate a transformation of the transformable apparatus in response to an external input. The external input herein may be generated outside of the transformable apparatus and received by the trigger mechanism on-board the transformable apparatus. The external input may be a user input instructing the trigger mechanism to initiate the transformation of the transformable apparatus, for example, between the vehicle configuration and the handheld configuration as discussed before.

As illustrated in Part A, the trigger mechanism may receive one or more external inputs via a state-switching interface 804. The state-switching interface may be one or more of a button, switch, dial, touchscreen, slider, knob, or key. The state-switching interface may analyze the content of the external input and determine if the external input is related to the transformation of the transformable apparatus. If this is the case, then the state-switching interface may transmit the external input to the trigger mechanism, which may initiate the transformation of the transformable apparatus between the vehicle configuration and the handheld configuration.

For example, when the state-switching interface is implemented as a knob on the body of the transformable apparatus, the user may twist the knob in a predetermined direction (e.g., clockwise) to indicate the trigger mechanism to initiate the transformation of the transformable apparatus from the vehicle configuration to the handheld configuration. The user may twist the knob in a direction opposite to the predetermined direction, e.g., in a counter-clockwise direction, to indicate the trigger mechanism to initiate the transformation of the transformable apparatus from the handheld configuration to the vehicle configuration. When the state-switching interface is implemented as two buttons, one of which indicates the transformation from the vehicle configuration to the handheld configuration and another of which indicates the transformation from the handheld configuration to the vehicle configuration, the user may select one of the buttons to indicate the trigger mechanism to initiate the transformation of the transformable apparatus into one of vehicle and handheld configurations.

Alternatively, in some implementations, without the state-switching interface as discussed above, the trigger mechanism may comprise a controlling part and a user interface part. The controlling part of the trigger mechanism may be arranged within the body of the transformable apparatus and the user interface of the trigger mechanism may be protruded out of the body or arranged on the external surface of the body for receiving external input. When the user interface receives the external input, it may transmit the external input to the controlling part. The controlling part may check if the external input may be relevant to the transformation of the transformable apparatus. If this is the case, the controlling part may initiate the transformation of the transformable apparatus, with aid of a processor or one or more actuators, as discussed previously. In some embodiments, the trigger mechanism may be implemented as one or more graphical elements, items or options, arranged on a touch sensitive display mounted or incorporated on the external surface of the transformable apparatus for user selection. Upon receipt of the user selection, such as touching or pressing one or more graphical elements, the trigger mechanism may trigger the transformation of the transformable apparatus with aid of one or more processors.

As shown at Part B of FIG. 8, a terminal device 806 remote to the transformable apparatus may provide the external input to a trigger mechanism 808. The terminal device herein may include but not be limited to a stationary device, a mobile station, a tablet, a smart phone, a pad, a portable digital assistance, or the like. In some instances, the external input may be provided wirelessly by the terminal device using any suitable communication techniques, for example, including a second Generation (2G), a third Generation (3G), a fourth Generation (4G, including Long Term Evolution (LTE)), a fifth Generation (5G) communication standards, short-distance communication techniques, such as wireless local network or Bluetooth. In some instances, the external input may be provided by the terminal device in a wired connection with the UAV, for example, via a cable or a USB line.

The external input herein may be implemented by touching or manual manipulation. For example, when a touch sensitive screen is used for receiving the external input, the user may touch different items, e.g., graphical objects or symbols, to select the desired configuration for the transformable apparatus. Upon receiving such a selection, the trigger mechanism may initiate the transformation of the transformable apparatus to the desired configuration. When one or more of physical keys, knobs, buttons, sliders or switches are provided for receiving the external input, the user may manually select the desired configuration by pressing, twisting, sliding, or switching manipulations.

The external input may be customized for the user. For example, the external input may be provided by a gesture or voice command from a user of the transformable apparatus. For example, the user may make a specified gesture or voice, and upon recognition of the specified gesture or voice with aid of a gesture or voice recognition device on-board the transformable apparatus, the trigger mechanism may initiate the transformation of the transformable apparatus. Alternatively, the external input may be provided by a change in orientation of the transformable apparatus or a terminal device initiated by a user. For example, upon detecting the orientation changes by inertial measurement units (IMUs) on-board the transformable apparatus, the trigger mechanism may initiate the transformation. As another example, when the user shakes or tilts the terminal device, an accelerometer or an IMU within the terminal device may detect such an orientation change and thus transmit an instruction as the external input to the trigger mechanism, instructing the trigger mechanism to initiate the transformation. In some embodiments, a heat-sensitive sensor may be arranged for receiving the external input. When detecting the temperature or heat made by user's touching, the heat-sensitive sensor may indicate the trigger mechanism to initiate the transformation.

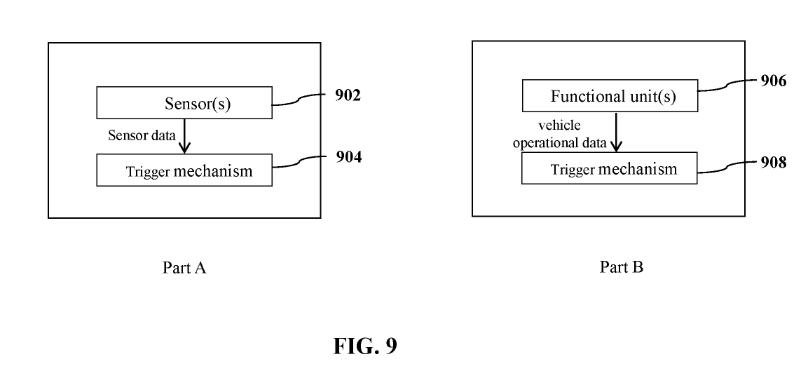

The trigger mechanism may be configured to initiate the transformation of the UAV between the vehicle configuration and the handheld configuration in response to different types of internal inputs, including sensor data or vehicle operational data, as shown respectively at Parts A and B of FIG. 9.

The internal inputs may be any instructions or data generated or collected from one or more components on-board or inside the transformable apparatus. The internal input may be measurement data, monitoring data or performance data of one or more components on-board or inside the transformable apparatus. The internal input may be generated regularly, periodically, or on an event-triggered basis, or based on a certain condition being met. In some embodiments, the internal input may comprise sensor data collected from one or more sensors on-board the transformable apparatus and/or vehicle operational data collected from one or more functional units on-board the transformable apparatus.

As shown at Part A of FIG. 9, one or more sensors 902 may generate sensor data. The sensors may include but are not limited to an inertial sensor, an altitude sensor, an attitude sensor, an acceleration sensor, an infrared sensor, or a depth sensor. In response to the sensor data collected or transmitted from the sensors, a trigger mechanism 904 may initiate the transformation of the transformable apparatus between the vehicle configuration and the handheld configuration.

For example, the altitude sensors may gather information indicative of the apparatus altitude relative to an underlying surface. The trigger mechanism may cause the transformable apparatus to transform from the vehicle configuration to the handheld configuration when the altitude sensors detect that the transformable apparatus is at or beneath a predetermined altitude relative to the underlying surface. As another example, the acceleration sensors may detect the acceleration of the apparatus in different configurations. When the acceleration sensors sense that the acceleration of the transformable apparatus is equal to or greater than a predetermined threshold, it may generate corresponding sensor data to instruct the trigger mechanism to change the configuration of the transformable apparatus. Similarly, when the acceleration sensor senses that the acceleration of the transformable apparatus is equal to or less than a predetermined threshold, it may generate corresponding sensor data to instruct the trigger mechanism to change the configuration of the transformable apparatus.

As shown at Part B of FIG. 9, one or more functional units 906 may generate vehicle operational data. The one or more functional units herein may include but are limited to a power system, a flight controller, an image transmission system, a propulsion system, a cooling system, a gimbal and an image capture device. The vehicle operational data may comprise data about operation of one or more functional units. In response to the vehicle operational data, a trigger mechanism 908 may initiate the transformation of the transformable apparatus between the vehicle configuration and handheld configuration. In some implementations, when the trigger mechanism determines that vehicle operational data is equal to, greater than, or less than a predetermined threshold, it may initiate the transformation of the transformable apparatus. For example, when the vehicle operational data indicates that the propulsion units are operating with a progressively decreased power, the trigger mechanism may initiate the transformation of the transformable apparatus from the vehicle configuration to the handheld configuration in response thereto. As another example, when the vehicle operational data indicates that the power system is operating at a higher power level than a predetermined power level, the trigger mechanism may initiate the transformation of the transformable apparatus from the handheld configuration to the vehicle configuration. In some implementations, the vehicle operational data of the flight controller may indicate that an electric speed controller is progressively decreasing the rotating speed of the propellers. In response to such vehicle operational data, the trigger mechanism may initiate the transformation of the transformable apparatus from the vehicle configuration to the handheld configuration. Thereby, the user may manually hold the transformable apparatus for ground level or lower operations.

The transformable apparatus may change its configurations and/or modes at different speeds depending on the type of trigger mechanism. The transformable apparatus may change configurations and/or modes with different degrees of verification or intervening steps depending on the type of trigger mechanism. Different types of the trigger mechanism may be given different priorities. For example, in some instances, the external input may be given higher priority than the internal input. Therefore, when receiving the external input, the trigger mechanism may immediately initiate the transformation of the transformable apparatus without any delay. In contrast, when receiving the internal input, the trigger mechanism may optionally require user confirmation or approval of the transformation, resulting in a slower transformation relative to the external input. In some instances, the internal input may be given higher priority than the external input. For example, when the internal input indicates that the transformation is needed, the trigger mechanism may immediately initiate the transformation without any delay. In contrast, when the external input is received, the trigger mechanism may determine whether the transformation is feasible based on the collected internal input. If the internal input shows that the transformation is not feasible or safe, then the trigger mechanism may not initiate the transformation. In this case, the trigger mechanism may notify the user of this situation. For example, the trigger mechanism may notify the use via the state-switching interface that the transformation is not permitted.

As discussed throughout the specification, the apparatus or transformable apparatus of the disclosure is very convenient for holding by user's hand when in the second or handheld configuration. For example, the transformable apparatus may have a dimension (e.g., length, width, and/or height) less than or equal to 50 cm, 40 cm, 30 cm, 20 cm, 19 cm, 18 cm, 17 cm, 16 cm, 15 cm, 14 cm, 13 cm, 12 cm, 11 cm, 10 cm, 9 cm, 8 cm, 7 cm, 6 cm, 5 cm, 4 cm, 3 cm, 2 cm, or 1 cm. Alternatively, the dimension (e.g., length, width, and/or height) may be greater than or equal to 50 cm, 40 cm, 30 cm, 20 cm, 19 cm, 18 cm, 17 cm, 16 cm, 15 cm, 14 cm, 13 cm, 12 cm, 11 cm, 10 cm, 9 cm, 8 cm, 7 cm, 6 cm, 5 cm, 4 cm, 3 cm, 2 cm, or 1 cm. Dimension may fall within a range between any values described herein. The length, width, and/or height may be the same or different from one another. In some instances, a maximum dimension (e.g., greatest of length, width, height, diagonal, or diameter) may be less than or equal to any of the values described herein. The length, width or height of the apparatus or transformable apparatus may be less than or greater than any of the described, or may be same or different from each other.

FIG. 10 provides a schematic of an interaction operation between a user interaction apparatus 1002 and a transformable apparatus 1004, in accordance with embodiments of the disclosure. The user interaction apparatus may interact with the transformable apparatus, thereby effecting the operation of the transformable apparatus. In some embodiments, the user interaction apparatus may effect the transformation of the transformable apparatus between a first configuration and a second configuration. One example of the first configuration is a vehicle configuration and one example of the second configuration is a handheld configuration. The transformable apparatus may be capable of self-propulsion with aid of one or more propulsion units when in the first configuration. The transformable apparatus may require manual manipulation for movement when in the second configuration.

The transformable apparatus herein may be share the same features, structures, or characteristics with those as discussed before or elsewhere in this specification. The transformable apparatus herein may be optionally identical to those as discussed before or elsewhere in this specification. Therefore, any descriptions about the transformable apparatus may also be applicable herein. Although the following will discuss the interaction between the user interaction apparatus and the transformable apparatus, the user interaction apparatus of the disclosure may also be used to interact with an apparatus that may not be transformable, such as the one discussed with reference to FIG. 5.

As shown in FIG. 10, the user interaction apparatus may comprise an interaction assembly 1006 and a performance assembly 1008. The interaction assembly may be configured to receive a user input to initiate movement of one or more components of a transformable apparatus. The performance assembly may effect the transformation of the transformable apparatus between a first configuration and a second configuration in response to the user input.

The movement of the one or more components of the transformable apparatus may include a rotation about one or more of a yaw, pitch, or roll axis of the transformable apparatus. When multiple components are movable, they move rotationally and/or translationally with respect to the same one, two, or three axes, or different axes. Movements may include pivoting, folding, sliding, telescoping, or any combination thereof, during transformation. In some implementations, the user input may be configured to cause one or more actuators to move components such that the transformable apparatus transforms between the first configuration and second configuration.

The performance assembly may be configured to effect a transformation of the transformable apparatus between the first configuration and the second configuration in response to the user input received by the interaction assembly. The performance assembly may communicate with the transformable apparatus to effect the transformation. The communication between the performance assembly and the transformable apparatus may be wireless or wired based on, for example, the distance between the user interaction apparatus and the transformable apparatus, channel bandwidth, communication link quality or the like. For example, if the transformable apparatus is far away from the user interaction apparatus in the first configuration, wireless communication may be established therebetween. Further, if the transformable apparatus is close to the user interaction apparatus or in proximity to the user interaction apparatus, wired communication may be established therebetween. Any descriptions of the wireless or wired communication made before or elsewhere in the specification may apply to the wireless or wired communication herein.

Upon receipt of the user input, the performance assembly may determine whether the user input is related to the transformation operation. If this is the case, it may instruct the transformable apparatus to transform into a configuration as indicated by the user input. In some implementations, an indication of the user input may be received by the performance assembly with aid of one or more processors on-board the transformable apparatus. In response to the indication of the user input, the performance assembly may generate, with aid of the one or more processors, an instruction that direct one or more actuators on-board the transformable apparatus to move the one or more components, thereby the transformable apparatus being in the expected configuration.

The performance assembly herein may be implemented in one of software including a firmware, hardware, or any combination thereof. In case the performance assembly is implemented by software, it may be a computer program, which may be stored in an on-board storage (e.g., flash or read only memory (ROM)) and perform two-way communication with the transformable apparatus when executed by one or more processors. When implemented by the hardware, the performance assembly may include one or more circuits or circuitries, which may be configured to receive the user input forwarded by the interaction assembly and perform two-way communication with the transformable apparatus, thereby causing the transformable apparatus to transform between the first configuration and the second configuration, as the arrows indicate.

In some embodiments, the transformable apparatus and/or the performance assembly may determine whether the transformation is possible based on, for example, internal input as discussed before. The transformable apparatus and/or the performance assembly may optionally send an interaction response to the user via the user interaction apparatus, particularly, via the interaction assembly. The interaction response may include confirmation information regarding whether the expected transformation is permitted or denied. In some instances, the confirmation information may include more details about why the transformation is denied. Alternatively, the interaction response may only be shown to the user when the transformation is denied.

In addition to effecting the transformation operations of the transformable apparatus, the user interaction apparatus may also capable of effecting or controlling operations of one or more functional units on-board the transformable apparatus. The one or more functional units may be selected from a group comprising a power system, a flight controller, an image transmission system, a propulsion system, a cooling system, a gimbal and an image capture device. The user interaction apparatus may change states of the one or more functional units between a first state and a second state, for example, based on the corresponding configuration of the transformable apparatus. For example, the user interaction apparatus may change the state of the one or more functional units into the first (or second) state when the transformable apparatus is in the first (or second) configuration. Therefore, the state of the one or more functional units may be adaptive to the configuration of the transformable apparatus.

In some embodiments, the user interaction apparatus may permit a first set of user inputs when the transformable apparatus is in the first configuration and the user interaction apparatus may permit a second set of inputs different from the first set of user inputs when the transformable apparatus is in the second configuration. In some instances, the first set of user inputs or the second set of user inputs may permit the enabling or disabling of one or more functional units on-board the transformable apparatus. For example, when the transformable apparatus is in the first configuration, the first set of user inputs may enable the propulsion system such that one or more propulsion units may operate in the first state. In contrast, when the transformable apparatus is in the second configuration, the second set of user inputs may disable the propulsion system such that one or more propulsion units may cease operation.

In some implementations, the first set of user inputs or the second set of user inputs may effect a setting of a gimbal or an image capture device on-board the transformable apparatus. For example, when the transformable apparatus is in the first configuration, the first set of user inputs may configure the gimbal or the image capture device to be more suitable for aerial photography, e.g., for panoramic imaging. When the transformable apparatus is in the second configuration, the second set of user inputs may configure the gimbal or the image capture device to be more suitable for ground photography, e.g., for 2D imaging. Any descriptions regarding settings of the gimbal or the image capture device made before or elsewhere in the specification may also be applicable herein.

In some embodiments, the user interaction apparatus may be configured to initialize one or more components of the transformable apparatus. The initialization herein may comprise configuring parameters, preferences, modes or states as initial options for one or more components. For example, based on one or more user selections, the user interaction apparatus may configure initial parameters of an image capture device attached to the transformable apparatus, or may configure a flight height, a flight distance, a flight duration for the flight controller, or may configure an average flight speed, a maximum flight speed, or a minimum flight speed for the one or more propulsion units.

The physical location of the user interaction apparatus can be flexibly arranged. In some implementations, the user interaction assembly may be on-board the transformable apparatus. The user interaction assembly may be removable from the transformable apparatus. The user interaction apparatus may be arranged on or embedded into a body of the transformable apparatus, e.g., a UAV body. In some instances, the user interaction apparatus may be at a first position on-board the transformable apparatus when the transformable apparatus is in the first configuration and a second position on-board the transformable apparatus different from the first position when the transformable apparatus is in the second configuration. The alternation between the first position and the second position may occur manually. For example, when the user interaction apparatus is arranged on the surface of the UAV body, the user may manually remove the user interaction apparatus from a side surface of the UAV body (i.e., the first positon) and attach it to a tail portion of the UAV body (i.e., second position) when the transformable apparatus transforms from the first configuration to the second configuration.

The user interaction apparatus may comprises one or more physical control elements configured to receive the user input, wherein the physical control elements may comprise one or more of a button, dial, knob, slider, switch, or key. In some embodiments, the physical control elements may be positioned to receive the user input by direct manual manipulation from the user while the user is holding at least a portion of the user interaction apparatus. Alternatively, the physical control elements may be positioned so that the user is capable of providing the user input while holding a handle of the user interaction apparatus. The use input may be a single action to the one or more physical control elements.

When the user interaction apparatus is on-board the transformable apparatus, the transformable apparatus may be ergonomically shaped for carrying by a single hand when in the first or handheld configuration. Alternatively, the transformable apparatus may comprise a handle ergonomically designed to be carried by a single hand when in the handheld configuration. In some instances, one or more components of the transformable apparatus may form the handle when the transformable apparatus is in the first or handheld configuration. Therefore, the user may grasp the handle to hold the transformable apparatus and make user inputs by operating the user interaction apparatus.

In some implementations, the user interaction apparatus may be configured to be coupled to and removed from the transformable apparatus with aid of a coupling element. For example, the user interaction apparatus may be removably mounted to transformable apparatus as a single one-piece. In some instances, the user interaction apparatus may have some interfaces and the transformable apparatus may have matching interfaces. When both the user interaction apparatus and the transformable apparatus are connected with each other via the interfaces at issue, the user may be able to control the transformation of the transformable apparatus and configure the various settings about one or more components of the transformable apparatus.

In some implementations, the user interaction apparatus may be on-board a terminal device. The user interaction apparatus may be releasably connected to the terminal device. The user interaction apparatus may be arranged on or embedded into a body of the terminal device, e.g., a main panel of the terminal device. The user interaction apparatus may be embodied as a display screen with some buttons, switches, sliders, or rockers around the periphery of the display screen. Alternatively, the user interaction apparatus may be embodied as a touch sensitive screen disposed or inlaid on the body of terminal device. Thereby, the user may input the selections by touching one or more virtual or graphic objects displayed on the screen. In some implementations, the user interaction apparatus may be embodied as a combination of the physical keys and virtual objects, as will be discussed in detail with reference to FIG. 11. In some implementations, the terminal device herein may be a wearable device into which the user interaction apparatus is embedded. The user may touch a display of the wearable device or push a button on the wearable device to input the user instructions.

The terminal device may use any suitable communication techniques to communicate with the transformable apparatus, such as wireless or wired communication. For example, when the user interaction apparatus on-board the terminal device receives user input from the user, it may instruct the terminal device to transmit an instruction via a transceiver included in the terminal device to the transformable apparatus. Upon receipt of such instruction, the transformable apparatus may perform the corresponding actions, for example, changing its own mode or configuration, or changing the states or settings of one or more functional units.

In some implementations, the interaction assembly may be on a terminal remote to the transformable apparatus and the performance assembly may be on-board the transformable apparatus. In other words, the interaction assembly and performance assembly may be separable from each other and can communicate with each other via any suitable wireless or wired communication. Therefore, the user may use the terminal to input user instructions via the user interaction assembly and the performance assembly on-board the transformable may effect the transformation of the transformable apparatus upon receiving the user instructions from the transformable apparatus.

In some implementations, the user interaction apparatus may have a dimension (e.g., length, width, and/or height) less than or equal to 40 cm, 35 cm, 30 cm, 25 cm, 20 cm, 15 cm, 14 cm, 13 cm, 12 cm, 11 cm, 10 cm, 9 cm, 8 cm, 7 cm, 6 cm, 5 cm, 4 cm, 3 cm, 2 cm, or 1 cm. Alternatively, the dimension (e.g., length, width, and/or height) may be greater than or equal to 40 cm, 35 cm, 30 cm, 25 cm, 20 cm, 15 cm, 14 cm, 13 cm, 12 cm, 11 cm, 10 cm, 9 cm, 8 cm, 7 cm, 6 cm, 5 cm, 4 cm, 3 cm, 2 cm, or 1 cm. Dimension may fall within a range between any values described herein. The length, width or height of the user interaction apparatus may be the same or different from each other. In some instances, a maximum dimension (e.g., greatest of length, width, height, diagonal, or diameter) may be less than or equal to any of the values described herein.

In some implementations, the user interaction apparatus may have a dimension (e.g., diameter and/or thickness) less than or equal to 25 cm, 20 cm, 15 cm, 12 cm, 11 cm, 10 cm, 9.5 cm, 9 cm, 8.5 cm, 8 cm, 7.5 cm, 7 m, 6.5 cm, 6 cm, 5.5 cm, 5 cm, 4.5 cm, 4 cm, 3.5 cm, 3 cm, 2.5 cm, 2 cm, 1.5 cm or 1 cm. Alternatively, the dimension (e.g., diameter and/or thickness) may be greater than or equal to 25 cm, 20 cm, 15 cm, 12 cm, 11 cm, 10 cm, 9.5 cm, 9 cm, 8.5 cm, 8 cm, 7.5 cm, 7 cm, 6.5 cm, 6 cm, 5.5 cm, 5 cm, 4.5 cm, 4 cm, 3.5 cm, 3 cm, 2.5 cm, 2 cm, 1.5 cm or 1 cm. Dimension may fall within a range between any values described herein. The diameter and/or thickness may be the same or different from one another. In some instances, a maximum dimension (e.g., greatest of length, width, height, thickness, diagonal, or diameter) may be less than or equal to any of the values described herein. The user interaction apparatus may have different shapes or dimensions that may be suitable for attachment to the UAV or a remote terminal.

The user interaction apparatus may be embodied as a display screen with some buttons, switches, sliders, or rockers around the periphery of the display screen. Alternatively, the user interaction apparatus may be embodied as a touch sensitive screen disposed or inlaid on the body of the transformable apparatus. Thereby, the user may input the selections by touching one or more virtual or graphic objects displayed on the screen. In some implementations, the user interaction apparatus may be embodied as a combination of the physical keys and virtual objects, as will be discussed in detail as follows with reference to FIG. 11.

FIG. 11 shows schematic views of different interaction assemblies with different dispositions for user interaction, in accordance with embodiments of the disclosure. The descriptions made regarding the interaction assembly with referent to the FIG. 10 may also be applied to the ones shown in FIG. 11.

As shown at Part A of FIG. 11, the interaction assembly 1102 may comprise a touchscreen 1104 configured to receive a user input, which may comprise an instruction to transform the transformable apparatus between the first configuration and the second configuration. The touchscreen may comprise a plurality of graphical objects 1106 that the user may touch to select the first configuration or the second configuration for the transformable apparatus. One or more graphical objects from said plurality of graphical objects may be used for changing the state of one or more functional units or sensors. For example, the one or more graphical objects may be used for changing the state of a flight controller, a cooling system, propulsion units, a gimbal, a carrier, an image capture device, an image transmission system, a power system or the like. In some implementations, the graphical objects may comprise one or more graphical objects that allow the user to control operations of a gimbal coupled to the transformable apparatus or an image capture device coupled to the transformable apparatus, thereby driving the image capture device coupled to the gimbal to rotate about one or more axes relative to the transformable apparatus.

In some implementations, the touchscreen may comprises a first plurality of graphical objects 1106-1 when the transformable apparatus is in the first configuration and a second plurality of graphical objects 1106-2 different from the first plurality of graphical objects when the transformable apparatus is in the second configuration. The first plurality of graphical objects may be used for changing the state of the one or more functional units or sensors into the first state for aerial operations or vehicle operations. The second plurality of graphical objects may be used for changing the state of the one or more functional units or sensors into the second state for handheld operations, or ground level or lower operations. Alternatively or in combination, the first plurality of graphical objects may also be used for changing settings or options of the one or more functional units or sensors for aerial operations or vehicle operations. The second plurality of graphical objects may be used for changing the settings or options of the one or more functional units or sensors for handheld operations, or ground level or lower operations. The first plurality of graphical objects and the second plurality of graphical objects may be the same graphical objects or may be different from each other.

Further, the interaction assembly may optionally comprise one or more physical control elements 1108 configured to receive the user input, wherein the physical control elements may comprise one or more of a button, dial, knob, slider, switch, or key. The physical control elements may be positioned to receive the user input by direct manual manipulation from the user while the user is holding at least a portion of the user interaction apparatus. Alternatively, the physical control elements may be positioned so that the user is capable of providing the user input while holding a handle of the user interaction apparatus. Further, the user input to initiate the transformation of the transformable apparatus may be a single action to the one or more physical control elements. In some implementations, a gimbal coupled to the transformable apparatus may be controlled by the user using the one or more physical control elements such that an image capture device coupled to the gimbal is driven to rotate about one or more axes relative to the transformable apparatus.

As shown at Part B of FIG. 11, the interaction assembly 1110 may comprise a state-switching interface 1112, which may be set as a physical control element. By a single touch of the state-switching interface, a different plurality of graphical objects 1114 may be displayed on a touchscreen 1116. For example, when touching the state-switching interface the first time, a first plurality of graphical objects may be displayed for the first configuration, e.g., vehicle configuration. When touching the state-switching interface the second time, a second plurality of graphical objects different from the first plurality of graphical objects may be displayed for the second configuration, e.g., handheld configuration. Therefore, the display of the first and second plurality of graphical objects may be alternate with aid of the state-switching interface.

As shown at Part C of FIG. 11, the interaction assembly 1118 may be implemented on a touchscreen without any physical control element. A first plurality of graphical objects 1120 for the first configuration and a second plurality of graphical objects 1122 for the second configuration may be displayed on the touchscreen together with a state-switching interface 1124 and a mode-switching interface 1126. By selecting the state-switching interface or the mode-switching interface, the transformable apparatus or one or more components of the transformable apparatus may be configured in the first or second state, or in the first mode or second mode, as discussed before or elsewhere in this specification. For example, by touching the mode-switching interface, the transformable apparatus may be transformed into the vehicle mode (or vehicle configuration) or the handheld mode (or handheld configuration). Then, by touching the state-switching interface, one or more components of the transformable apparatus may be correspondingly changed into a first state or a second state. The graphical control objects herein may be implemented as various icons with words to indicate a variety of functional units, thereby making it easy to configure the functional units.

In alternative embodiments, the first plurality of graphical objects 1120 may be used for configuring or changing the states or settings of the one or more functional units and the second plurality of graphical objects 1122 may be used for configuring or changing the states or settings of one or more sensors. The state-switching interface 1124 may be used for triggering the transformation of the transformable apparatus and the mode-switching interface 1126 may be used for switching the mode of the apparatus. The changing of the states or settings of the functional units may be before, after, or concurrently with the changing of the configuration or mode of the transformable apparatus.

As previously discussed, the user input may optionally be made by attitude and/or motion. For example, when the user interaction apparatus comprises an Inertial Measurement Unit (IMU) or similar units, it may detect its own attitude and/or motion. When the user changes the orientation of the user interaction apparatus, for example, by shaking or tilting the transformable apparatus on which the user interaction apparatus is arranged in a predetermined direction, the use input may be formed and received by the user interaction apparatus, thereby changing the configuration of the transformable apparatus, the mode of the apparatus, or the settings of the one or more functional units.

FIG. 12 shows different schematic views of an unmanned aerial vehicle (UAV) transformed between a first configuration and a second configuration, in accordance with embodiments of the disclosure. It is to be understood that the UAV herein may be one physical implementation of the transformable apparatus as discussed before. Therefore, any description made before regarding the transformable apparatus may also be applied herein. For example, as discussed before, the UAV may have a first configuration and a second configuration via transformation, which may be achieved by moving one or more components of the UAV relative to another component of the UAV. The first configuration may be a vehicle configuration and the second configuration may be a handheld configuration. The UAV may be capable of self-propulsion while capturing images when in the vehicle configuration and may require manual manipulation for movement while capturing images when in the handheld configuration. Alternatively or additionally, the UAV may be configured for aerial operation when in the vehicle configuration and may be configured for ground level operation or lower when in the handheld configuration.

As illustrated at Part A of FIG. 12, a UAV 1202 may comprise a UAV body 1204 and a plurality of arms 1206 extendable from the central body, for example arms 1206-1, 1206-2, 1206-3, and 1206-4 laterally disposed around the UAV body. Each of said plurality of arms may support one or more propulsion units, for example propulsion units 1208-1, 1208-2, 1208-3, and 1208-4. The propulsion units may include one or more rotating components, such as rotor blades 1210-1, 1210-2, 1210-3 and 1210-4. The propulsion may additionally include shafts or actuators. The rotating components may rotate in any direction. The UAV may also comprise one or more landing gears, such as landing gears 1212-1 and 1212-2, for landing on a surface, such as on the ground. Further arranged on the UAV is a power button or switch 1214 capable of powering on or off the UAV.

The UAV shown at Part A may be in a first configuration or a vehicle configuration. In the first configuration or the vehicle configuration, the UAV may perform aerial operations, such as aerial photography, collection of environmental data, aerial surveillance, aerial survey, real-time image transmission, etc. For instance, the UAV may perform the aerial photography when an image capture device is coupled to the UAV, which may be controlled in real time by an operator in a wireless manner.

In some embodiments, aerial operations, such as flight of the UAV, may be controlled with aid of a remote terminal. For instance, the remote terminal may initiate flight of the UAV and/or landing of the UAV. The remote terminal may initiate one or more predetermined flight sequence or a type of flight mode. The UAV may be capable of autonomous, semi-autonomous, or direct manual controlled flight.

The remote terminal may comprise a user interaction apparatus as discussed before with respect to FIGS. 10 and 11. With aid of the user interaction apparatus, a user may interact with the remote terminal to control flight of the UAV or initiate a transformation of the UAV from the first configuration to the second configuration as shown at Part B of FIG. 11.

As illustrated in Part B, with or without aid of a trigger mechanism on-board the UAV, the UAV may be transformed into the second configuration, i.e., the handheld configuration. In some instances, the transformation or movement of the one or more arms may occur automatically in response to a sensed condition, or a command to land or take-off. The transformation shown herein is completed by laterally folding one or more arms, such as arms 1206-1, 1206-2, and 1206-4, and leaving arm 1206-3 as a handle.

Part C of FIG. 12 shows a UAV 1203 which may have a similar mechanical structure to the UAVs shown in Parts A and B. The differences therebetween are one or more user interfaces 1216, which are being pressed by a thumb of a human hand 1218. The user interfaces herein may be a physical example of an interaction assembly of the user interaction assembly as discussed before with reference to FIGS. 10 and 11. By using the arm of the UAV as a handle for holding, the user may be able to interact with the UAV in the handheld configuration.

As previously noted, in some instances, the user may be able to configure one or more components of the UAV such that they are more suitable for the handheld configuration. In particular, the user may be able to configure or amend one or more parameters about a power system, a flight controller, an image transmission system, a propulsion system, a cooling system, a gimbal and an image capture device, thereby changing their states from a first state in the vehicle configuration to a second state in the handheld configuration. For example, the user may be able to configure the image capture device such that it may have a wider angle of image capture in the first state relative to the second state.

FIG. 13 shows different schematic views of a UAV 1302 transformed into a handheld or tripod configuration, in accordance with embodiments of the disclosure. The UAV herein may be just transformed from a vehicle configuration with aid of a trigger mechanism or a user interaction apparatus as discussed before. For example, upon initiating by the trigger mechanism, the UAV may transform from the aerial configuration to the handheld configuration, including the tripod configuration as shown in each of Parts B, C, D, and E of FIG. 13.

The UAV 1302 may comprise a UAV body 1304 and a plurality of arms 1306. Although the arms are shown herein as parallel to each other, they may be angled with respect to each other by a certain degree. For example, two adjacent arms of the UAV may be angled with respect to each other by 90 degrees. One or more propulsion units including one or more rotor blades 1308 are supported by each arm at its distal end. Optionally, the UAV may comprise an image capture device 1310 which is coupled to a gimbal 1312. The gimbal may be removably attached to the bottom of the UAV body. The gimbal may be able to drive the image capture device to rotate in at least one axis of a yaw axis, a roll axis, and a pitch axis relative to the UAV body.

The user may directly hold the UAV as shown at Part A of FIG. 13 to take photos or record video. Further, if the proper balance is maintained, the UAV may be placed on the ground or resting on a flat surface. Therefore, the image capture device may be able to take photos on the ground level or even lower level, e.g., under the water if the UAV and image capture device are waterproof

As shown at Part B of FIG. 13, the UAV as a whole is rotated by 180 degrees relative to the one shown at Part A and arms become leg for supporting the UAV body. As illustrated, each arm is folded by a certain degree such that an included angle is formed between a supporting plane (e.g., ground) and each arm. By using the distal ends of the arms as supporting points, the UAV may be steadily resting on the supporting plane, and the image device, whose orientation changes to be on the top of the UAV body, may be able to take images using a wider angle of view. In this manner, the image capture device may be changed from the first state where a narrow angle of view may be applied into the second state where a wider angle of view may be applied due to the change of the orientation. In some embodiments, a stabilization assembly or device may be attached to the image capture device, e.g., beneath the image capture device, such that the vibration resulting from the gravity of the image capture device may be equipoised by an elastic force provided by the stabilization assembly in the vertical direction.

In some embodiments, a user interaction apparatus as discussed before may be disposed on the UAV body, for example, an interaction assembly 1314 arranged on the external surface of the UAV body. With aid of the interaction assembly, the user is able to configure parameters or change states of one or more functional units of the UAV. For example, since the UAV is now in the handheld configuration including functioning as a camera support device, the user may shut down the propulsion units of the UAV by the interaction assembly. Further, the UAV may reduce the power level of the cooling system since the propulsion or movement of the UAV may mostly depend on the manual manipulation and less heat may be generated relative to the vehicle configuration. In some instances, with aid of the interaction assembly, the user may adjust the photographic parameters, such as attitude parameters of camera pan and tilt, zoom parameters, a shutter speed, exposure modes, operating modes, resolutions, scenario modes, etc.

As shown in Part C of FIG. 13, the arms of the UAV may be further folded outwardly such that they may be parallel to the supporting plane. In this manner, the UAV may be supported by the propellers as shown. Alternatively, the propellers may be removed from the arms such that the arms may rest directly on the supporting plane, thereby further increasing the stability of the UAV as a camera support device or a tripod.

As an alternative, as shown at Part D of FIG. 13, the arms may be folded to be vertical to the supporting plane, thereby becoming legs for supporting the UAV body and image capture device together with the gimbal. A holder 1316 may be arranged on the outer surface of the UAV body for holding a mobile device, such as a mobile phone 1320, as shown at Part E of FIG. 13. The user interaction apparatus as discussed before may be included in the mobile phone and the user may be able to interact with the UAV via the user interaction apparatus. Further, the user may view the image or video on the screen of the mobile phone in real time. Additionally, some knobs or buttons 1318 may be disposed on the outer surface of the UAV body such that the user may control some functional units or components of the UAV, for example, changing their options, states, or settings. For example, by pressing the buttons. the user may be able to change the output state of the battery units.

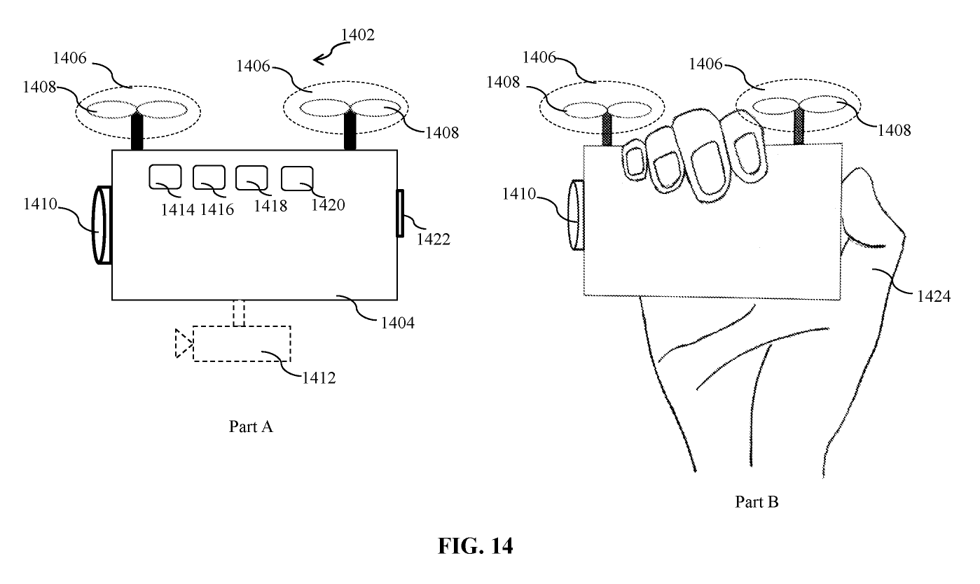

FIG. 14 shows different schematic views of a UAV 1402 in a first mode and a second mode, in accordance with embodiments of the disclosure. The UAV herein may be an apparatus as discussed before with reference to FIG. 5. The UAV herein may be not transformable. For example, the UAV may be capable of self-propulsion when in the first mode and may be configured to require manual manipulation for movement when in the second mode. Alternatively, the UAV may be configured for aerial operation when in the first mode and may be configured for ground level operation or lower when in the second mode.

As shown at Part A of FIG. 14, the UAV in the first mode may comprise a UAV body 1404, a plurality of propulsion units 1406 and rotor blades 1408 carried by the propulsion units. Unlike the UAV discussed before, the propulsion units shown herein may be directly attached to the UAV body without arms, thereby further reducing the size or weight of the UAV. An image capture device 1410 may be attached to the UAV body, for example, at the head of the UAV body for forward shooting. Alternatively, an image capture device 1412 may be mounted to the bottom of the UAV body for photography. Optionally, the image capture device may be supported by a gimbal, which may be removably attached to the UAV body. Thereby, the image capture device may be controlled by the gimbal to rotate about one or more axes relative to the UAV body.

Further arranged on the UAV body are control buttons, keys, or knobs 1414, 1416, 1418, and 1420. In some embodiments, other user interfaces may further be arranged on the UAV, which may comprise one or more of a switch, a dial, or a touchscreen. The user interfaces herein may be an interaction assembly or a part thereof, as discussed before with reference to FIGS. 10 and 11.

As shown at Part B of FIG. 14, the UAV is now in the second mode where a single hand 1424 is holding the UAV for handheld operations. In some embodiments, the UAV may transform from the first mode to the second mode without any transformation. In some embodiments, the UAV may transform from the first mode to the second mode with aid of a trigger mechanism as discussed before. For example, when detecting that the user shut down the propellers, the trigger mechanism may change the UAV from the first mode for aerial operations into the second mode for handheld operations. Alternatively, the UAV may transform between the first mode and the second mode with aid of a user interaction apparatus. In some instances, the user interaction apparatus may be embedded in the UAV such that the user may easily change the modes of the UAV.

As shown, the user may use his or her finger to change the modes of the UAV, states, parameters, or preferences of the one or more functional units while holding the UAV for handheld operations. For example, by pressing the buttons, the user may adjust the resolution of the camera, enable or disenable some components, such as propellers, change the state of the cooling system, and the like.

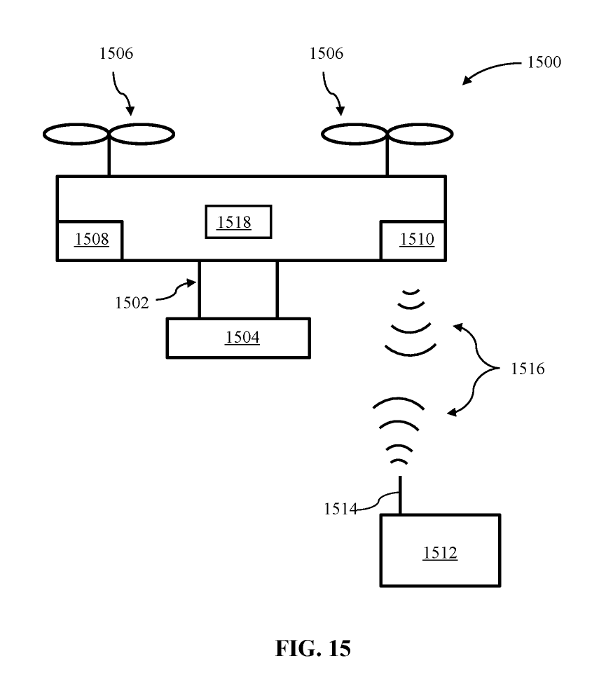

FIG. 15 illustrates a movable object 1500 including a carrier 1502 and a payload 1504, in accordance with embodiments. Although the movable object 1500 is depicted as an aircraft, this depiction is not intended to be limiting, and any suitable type of movable object can be used, as previously described herein. One of skill in the art would appreciate that any of the embodiments described herein in the context of aircraft systems can be applied to any suitable movable object (e.g., an UAV). In some instances, the payload 1504 may be provided on the movable object 1500 without requiring the carrier 1502. The movable object 1500 may include propulsion mechanisms 1506, a sensing system 1508, and a communication system 1510.

The propulsion mechanisms 1506 can include one or more of rotors, propellers, blades, engines, motors, wheels, axles, magnets, or nozzles, as previously described. For example, the propulsion mechanisms 1506 may be self-tightening rotors, rotor assemblies, or other rotary propulsion units, as disclosed elsewhere herein. The movable object may have one or more, two or more, three or more, or four or more propulsion mechanisms. The propulsion mechanisms may all be of the same type. Alternatively, one or more propulsion mechanisms can be different types of propulsion mechanisms. The propulsion mechanisms 1506 can be mounted on the movable object 1500 using any suitable means, such as a support element (e.g., a drive shaft) as described elsewhere in this specification. The propulsion mechanisms 1506 can be mounted on any suitable portion of the movable object 1500, such on the top, bottom, front, back, sides, or suitable combinations thereof.

In some embodiments, the propulsion mechanisms 1506 can enable the movable object 1500 to take off vertically from a surface or land vertically on a surface without requiring any horizontal movement of the movable object 1500 (e.g., without traveling down a runway). Optionally, the propulsion mechanisms 1506 can be operable to permit the movable object 1500 to hover in the air at a specified position and/or orientation. One or more of the propulsion mechanisms 1506 may be controlled independently of the other propulsion mechanisms. Alternatively, the propulsion mechanisms 1506 can be configured to be controlled simultaneously. For example, the movable object 1500 can have multiple horizontally oriented rotors that can provide lift and/or thrust to the movable object. The multiple horizontally oriented rotors can be actuated to provide vertical takeoff, vertical landing, and hovering capabilities to the movable object 1500. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable object 1500 (e.g., with respect to up to three degrees of translation and up to three degrees of rotation).

The sensing system 1508 can include one or more sensors that may sense the spatial disposition, velocity, and/or acceleration of the movable object 1500 (e.g., with respect to up to three degrees of translation and up to three degrees of rotation). The one or more sensors can include global positioning system (GPS) sensors, motion sensors, inertial sensors, proximity sensors, or image sensors. The sensing data provided by the sensing system 1508 can be used to control the spatial disposition, velocity, and/or orientation of the movable object 1500 (e.g., using a suitable processing unit and/or control module, as described below). Alternatively, the sensing system 1508 can be used to provide data regarding the environment surrounding the movable object, such as weather conditions, proximity to potential obstacles, location of geographical features, location of manmade structures, and the like. In some embodiments, the trigger mechanism as discussed before may transform, based on the data collected by the sensing system 1508, configurations or modes of the movable object 1500 between the first configuration (or mode) and the second configuration (or mode).

The communication system 1510 enables communication with terminal 1512 having a communication system 1514 via wireless signals 1516. The communication systems 1510, 1514 may include any number of transmitters, receivers, and/or transceivers suitable for wireless communication. The communication may be one-way communication, such that data can be transmitted in only one direction. For example, one-way communication may involve only the movable object 1500 transmitting data to the terminal 1512, or vice-versa. The data may be transmitted from one or more transmitters of the communication system 1510 to one or more receivers of the communication system 1512, or vice-versa. Alternatively, the communication may be two-way communication, such that data can be transmitted in both directions between the movable object 1500 and the terminal 1512. The two-way communication can involve transmitting data from one or more transmitters of the communication system 1510 to one or more receivers of the communication system 1514, and vice-versa.

In some embodiments, the terminal 1512 can provide control data to one or more of the movable object 1500, carrier 1502, and payload 1504 and receive information from one or more of the movable object 1500, carrier 1502, and payload 1504 (e.g., position and/or motion information of the movable object, carrier or payload; data sensed by the payload such as image data captured by a payload camera). In some instances, control data from the terminal may include instructions for relative positions, movements, actuations, or controls of the movable object, carrier and/or payload. For example, the control data may result in a modification of the location and/or orientation of the movable object (e.g., via control of the propulsion mechanisms 1506), or a movement of the payload with respect to the movable object (e.g., via control of the carrier 1502). The control data from the terminal may result in control of the payload, such as control of the operation of a camera or other image capture device (e.g., taking still or moving pictures, zooming in or out, turning on or off, switching imaging modes, change image resolution, changing focus, changing depth of field, changing exposure time, changing viewing angle or field of view). In some instances, the communications from the movable object, carrier and/or payload may include information from one or more sensors (e.g., of the sensing system 1508 or of the payload 1504). The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable object, carrier and/or payload. Such information from a payload may include data captured by the payload or a sensed state of the payload. The control data provided transmitted by the terminal 1512 can be configured to control a state of one or more of the movable object 1500, carrier 1502, or payload 1504. Alternatively or in combination, the carrier 1502 and payload 1504 can also each include a communication module configured to communicate with terminal 1512, such that the terminal can communicate with and control each of the movable object 1500, carrier 1502, and payload 1504 independently.

In some embodiments, the terminal 1512 may include a user interaction apparatus as discussed before for interacting with the movable object 1500. For example, with aid of the user interaction apparatus, the terminal 1512 may receive a user input to initiate the transformation of the movable object 1500 from a vehicle configuration to a handheld configuration. The terminal 1512 may be physically attached to the movable object 1500 when the movable object 1500 is in the handheld configuration, thereby improving the usability and portability of the moveable object 1500.

In some embodiments, the movable object 1500 can be configured to communicate with another remote device in addition to the terminal 1512, or instead of the terminal 1512. The terminal 1512 may also be configured to communicate with another remote device as well as the movable object 1500. For example, the movable object 1500 and/or terminal 1512 may communicate with another movable object, or a carrier or payload of another movable object. When desired, the remote device may be a second terminal or other computing device (e.g., computer, laptop, tablet, smartphone, or other mobile device). The remote device can be configured to transmit data to the movable object 1500, receive data from the movable object 1500, transmit data to the terminal 1512, and/or receive data from the terminal 1512. Optionally, the remote device can be connected to the Internet or other telecommunications network, such that data received from the movable object 1500 and/or terminal 1512 can be uploaded to a website or server.

According to the embodiments of the disclosure, the movable object 1500 may be of different configurations or different modes, such as those discussed before or elsewhere in this specification. When the moveable object 1500 supports different configurations, it may be a transformable apparatus as discussed before and may be capable of transforming between a first configuration (e.g., vehicle configuration) and a second configuration (e.g., handheld configuration). When the moveable object 1500 supports different modes, it may be an apparatus as discussed with reference to FIG. 5 and may be capable of changing between a first mode and a second mode.

The movable object 1500 may additionally include a user interface 1518. In some implementations, the user interface 1518 may be or include the user interaction apparatus as discussed before. Therefore, the user interface 1518 may receive external input including user input and change the configurations or modes of the movable object 1500 in response to the received input. For example, the user interface may change the movable object 1500 from a first configuration for aerial operations to a second configuration for handheld operations, or vice versa. As another example, the user interface may change the movable object 1500 from a first mode for aerial operations to a second mode for handheld operations, or vice versa. Further, the user interface may receive the user input to change the states or settings of one or more functional units on-board the movable object 1500.

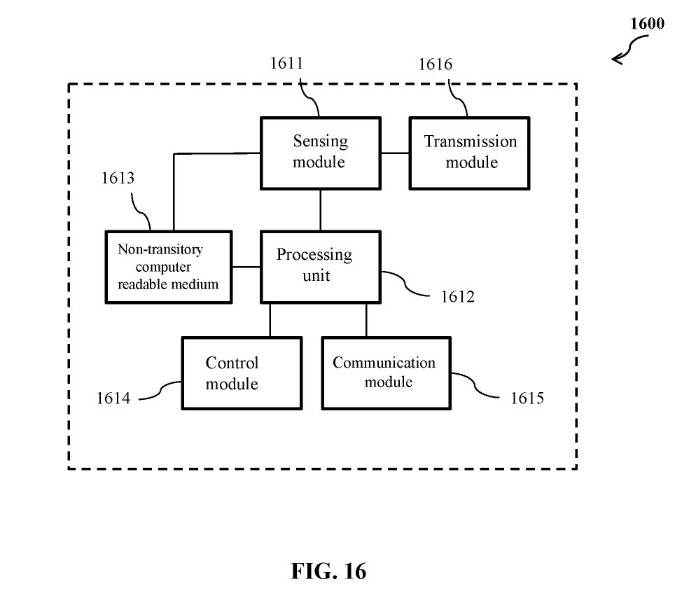

FIG. 16 is a schematic illustration by way of block diagram of a system 1600 for controlling a movable object, in accordance with embodiments. The system 1600 can be used in combination with any suitable embodiment of the systems, devices, and methods disclosed herein. The system 1600 can include a sensing module 1611, processing unit 1612, non-transitory computer readable medium 1613, control module 1614, communication module 1615 and transmission module 1616.

The sensing module 1611 can utilize different types of sensors that collect information relating to the movable objects in different ways. Different types of sensors may sense different types of signals or signals from different sources. For example, the sensors can include inertial sensors, GPS sensors, proximity sensors (e.g., lidar), or vision/image sensors (e.g., a camera). The sensing module 1611 can be operatively coupled to a processing unit 1612 having a plurality of processors. In some embodiments, the sensing module can be operatively coupled to a transmission module 1616 (e.g., a Wi-Fi image transmission module) configured to directly transmit sensing data to a suitable external device or system. For example, the transmission module 1616 can be used to transmit images captured by a camera of the sensing module 1611 to a remote terminal.

The processing unit 1612 can have one or more processors, such as a programmable processor (e.g., a central processing unit (CPU)). The processing unit 1612 can be operatively coupled to a non-transitory computer readable medium 1613. The non-transitory computer readable medium 1613 can store logic, code, and/or program instructions executable by the processing unit 1604 for performing one or more steps or functions of a performance assembly as illustrated in FIG. 10. The non-transitory computer readable medium can include one or more memory units (e.g., removable media or external storage such as an SD card or random access memory (RAM)). In some embodiments, data from the sensing module 1611 can be directly conveyed to and stored within the memory units of the non-transitory computer readable medium 1613. The memory units of the non-transitory computer readable medium 1613 can store logic, code and/or program instructions executable by the processing unit 1612 to perform any suitable embodiment of the methods described herein. For example, the processing unit 1612 can be configured to execute instructions causing one or more processors of the processing unit 1612 to analyze sensing data produced by the sensing module and change configurations or modes of the movable object. The memory units can store sensing data from the sensing module to be processed by the processing unit 1612. In some embodiments, the memory units of the non-transitory computer readable medium 1613 can be used to store the processing results produced by the processing unit 1612.

In some embodiments, the processing unit 1612 can be operatively coupled to a control module 1614 configured to control a state or mode of the movable object. For instance, the control module 1614 can be configured to control the propulsion mechanisms of the movable object to adjust the spatial disposition, velocity, and/or acceleration of the movable object with respect to six degrees of freedom. Alternatively or in combination, the control module 1614 can control one or more of a state of one or more functional units including but not limited to a carrier, payload, or sensing module.

The processing unit 1612 can be operatively coupled to a communication module 1615 configured to transmit and/or receive data from one or more external devices (e.g., a terminal, display device, or other remote controller). Any suitable means of communication can be used, such as wired communication or wireless communication. For example, the communication module 1615 can utilize one or more of local area networks (LAN), wide area networks (WAN), infrared, radio, WiFi, point-to-point (P2P) networks, telecommunication networks, cloud communication, and the like. Optionally, relay stations, such as towers, satellites, or mobile stations, can be used. Wireless communications can be proximity dependent or proximity independent. In some embodiments, line-of-sight may or may not be required for communications. The communication module 1615 can transmit and/or receive one or more of sensing data from the sensing module 1611, processing results produced by the processing unit 1612, predetermined control data, user commands from a terminal or remote controller, and the like.

The components of the system 1600 can be arranged in any suitable configuration. For example, one or more of the components of the system 1600 can be located on the movable object, carrier, payload, terminal, sensing system, or an additional external device in communication with one or more of the above. Additionally, although FIG. 16 depicts a single processing unit 1612 and a single non-transitory computer readable medium 1613, one of skill in the art would appreciate that this is not intended to be limiting, and that the system 1600 can include a plurality of processing units and/or non-transitory computer readable media. In some embodiments, one or more of the plurality of processing units and/or non-transitory computer readable media can be situated at different locations, such as on the movable object, carrier, payload, terminal, sensing module, additional external device in communication with one or more of the above, or suitable combinations thereof, such that any suitable aspect of the processing and/or memory functions performed by the system 1600 can occur at one or more of the aforementioned locations.

While some embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the invention and that methods and structures within the scope of these claims and their equivalents be covered thereby.

What is claimed is:

1. A transformable apparatus comprising:
one or more components configured to be movable relative to another component of the transformable apparatus;
a trigger mechanism configured to initiate a transformation of the transformable apparatus between a vehicle configuration and a handheld configuration at least in part by causing a movement of the one or more components relative to the other component; and
one or more propulsion units configured to effect self-propulsion of the transformable apparatus when the transformable apparatus is in the vehicle configuration,
wherein the transformable apparatus is configured to be held by a human hand when in the handheld configuration.

2. The transformable apparatus of claim 1, wherein the trigger mechanism is configured to initiate the transformation between the vehicle configuration and the handheld configuration in response to an external input provided via a state-switching interface of the transformable apparatus.

3. The transformable apparatus of claim 2, wherein the state-switching interface is a button, switch, dial, touchscreen, slider, knob, or key.

4. The transformable apparatus of claim 1, wherein the trigger mechanism is configured to initiate the transformation between the vehicle configuration and the handheld configuration in response to an external input provided wirelessly by a terminal device remote to the transformable apparatus.

5. The transformable apparatus of claim 1, wherein the trigger mechanism is configured to initiate the transformation between the vehicle configuration and the handheld configuration in response to an external input provided by a gesture or voice command from a user of the transformable apparatus.

6. The transformable apparatus of claim 1, wherein the trigger mechanism is configured to initiate the transformation between the vehicle configuration and the handheld configuration in response to an external input provided by a change in orientation of the transformable apparatus initiated by a user.

7. The transformable apparatus of claim 1, wherein the trigger mechanism is configured to initiate the transformation of the transformable apparatus between the vehicle configuration and the handheld configuration in response to sensor data or vehicle operational data.

8. The transformable apparatus of claim 7, wherein the sensor data comprises data collected by one or more of an inertial sensor, an altitude sensor, an attitude sensor, an acceleration sensor, an infrared sensor, or a depth sensor.

9. The transformable apparatus of claim 1, further comprising one or more functional units configured to operate in a first state when the transformable apparatus is in the vehicle configuration and configured to operate in a second state different from the first state when the transformable apparatus is in the handheld configuration.

10. The transformable apparatus of claim 1, wherein the transformable apparatus is ergonomically shaped for carrying by a single hand when in the handheld configuration.

11. The transformable apparatus of claim 1, wherein the one or more components form a handle when the transformable apparatus is in the handheld configuration, the handle being ergonomically designed to be carried by a single hand when in the handheld configuration.

12. The transformable apparatus of claim 11, wherein the one or more components that form the handle comprise an arm supporting a propulsion unit that effects self-propulsion of the transformable apparatus when the transformable apparatus is in the vehicle configuration.

13. The transformable apparatus of claim 11, wherein the handle comprises a grasping region configured to permit a user's fingers to at least partially wrap around the grasping region.

14. The transformable apparatus of claim 13, further comprising a user input interface configured to receive an input from the single hand while the user's fingers are at least partially wrapped around the grasping region.

15. The transformable apparatus of claim 14, wherein the input received by the user input interface effects operation of the transformable apparatus while the transformable apparatus is in the handheld configuration.

16. The transformable apparatus of claim 1, further comprising:
one or more image capture devices or one or more interfaces to receive the one or more image capture devices,
wherein the one or more image capture devices are configured to capture images when the transformable apparatus is in the vehicle configuration and in the handheld configuration.

17. The transformable apparatus of claim 1, further comprising a user interface for receiving a user input to control operations of one or more functional units selected from a group comprising a power system, a flight controller, an image transmission system, a propulsion system, a cooling system, a gimbal, and an image capture device.

18. The transformable apparatus of claim 17, wherein the gimbal is controlled by the user input such that the image capture device coupled to the gimbal is driven to rotate about one or more axes.
